(19) United States
(12) Patent Application Publication
(10) Pub. No.: US 2025/0350574 A1
(43) Pub. Date: Nov. 13, 2025

(54) USER INTERFACES FOR COMPOSING MESSAGES

(71) Applicant: Apple Inc., Cupertino, CA (US)

(72) Inventors: Christian X. DALONZO, San Francisco, CA (US); Stephen O. LEMAY, Palo Alto, CA (US)

(21) Appl. No.: 19/203,080

(22) Filed: May 8, 2025

Related U.S. Application Data
(60) Provisional application No. 63/646,779, filed on May 13, 2024.
(60) Provisional application No. 63/657,055, filed on Jun. 6, 2024.

(51) Int. Cl. H04L 51/226; H04L 51/04

(52) U.S. Cl. CPC H04L 51/226; H04L 51/04

(57) ABSTRACT

The present disclosure generally relates to composing messages in various user interfaces. In some examples, the computer system composes a plurality of messages in a delayed messaging mode. In some examples, the computer system concurrently displays delayed messages and transmitted messages in different sections of a message transcript. In some embodiments, the computer system displays an interface for customizing the visual representation of a linked message to be transmitted in a messaging section.

### CROSS-REFERENCE TO RELATED APPLICATIONS

This application claims priority to U.S. Provisional Patent Application No. 63/657,055 entitled “USER INTERFACES FOR COMPOSING MESSAGES,” filed Jun. 6, 2024 and U.S. Provisional Patent Application No. 63/646,779 entitled “USER INTERFACES FOR COMPOSING MESSAGES,” filed May 13, 2024, the contents of which are hereby incorporated by reference in their entirety.

### FIELD

The present disclosure relates generally to computer user interfaces, and more specifically to techniques for composing messages in various user interfaces.

### BACKGROUND

Electronic computer systems provide means for composing messages in various user interfaces.

### BRIEF SUMMARY

Some techniques for composing messages in various user interfaces using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for composing messages in various user interfaces. Such methods and interfaces optionally complement or replace other methods for composing messages in various user interfaces. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with a display generation component and one or more input devices: while displaying, via the display generation component, a messaging user interface, receiving, via the one or more input devices, a first set of one or more inputs; in response to receiving the first set of one or more inputs, activating a delayed messaging mode, wherein the computer system is configured to schedule delayed transmission times of respective messages while operating in the delayed messaging mode; and while operating in the delayed messaging mode: composing a first message; and composing a second message, wherein the first message and the second message are scheduled to be transmitted at a first predetermined time.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: while displaying, via the display generation component, a messaging user interface, receiving, via the one or more input devices, a first set of one or more inputs; in response to receiving the first set of one or more inputs, activating a delayed messaging mode, wherein the computer system is configured to schedule delayed transmission times of respective messages while operating in the delayed messaging mode; and while operating in the delayed messaging mode: composing a first message; and composing a second message, wherein the first message and the second message are scheduled to be transmitted at a first predetermined time.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: while displaying, via the display generation component, a messaging user interface, receiving, via the one or more input devices, a first set of one or more inputs; in response to receiving the first set of one or more inputs, activating a delayed messaging mode, wherein the computer system is configured to schedule delayed transmission times of respective messages while operating in the delayed messaging mode; and while operating in the delayed messaging mode: composing a first message; and composing a second message, wherein the first message and the second message are scheduled to be transmitted at a first predetermined time.

In accordance with some embodiments, a computer system configured to communicate with a display generation component and one or more input devices is described. The computer system comprises one or more processors and memory storing one or more programs configured to be executed by the one or more processors. The one or more programs include instructions for: while displaying, via the display generation component, a messaging user interface, receiving, via the one or more input devices, a first set of one or more inputs; in response to receiving the first set of one or more inputs, activating a delayed messaging mode, wherein the computer system is configured to schedule delayed transmission times of respective messages while operating in the delayed messaging mode; and while operating in the delayed messaging mode: composing a first message; and composing a second message, wherein the first message and the second message are scheduled to be transmitted at a first predetermined time.

In accordance with some embodiments, a computer system configured to communicate with a display generation component and one or more input devices is described. The computer system comprises: means for, while displaying, via the display generation component, a messaging user interface, receiving, via the one or more input devices, a first set of one or more inputs; means for, in response to receiving the first set of one or more inputs, activating a delayed messaging mode, wherein the computer system is configured to schedule delayed transmission times of respective messages while operating in the delayed messaging mode; and means for, while operating in the delayed messaging mode: composing a first message; and composing a second message, wherein the first message and the second message are scheduled to be transmitted at a first predetermined time.

In accordance with some embodiments, a computer program product is described. The computer program product comprises one or more programs configured to be executed by one or more processors of a computer system that is in communication with a display generation component and one or more input devices. The one or more programs include instructions for: while displaying, via the display generation component, a messaging user interface, receiving, via the one or more input devices, a first set of one or more inputs; in response to receiving the first set of one or more inputs, activating a delayed messaging mode, wherein the computer system is configured to schedule delayed transmission times of respective messages while operating in the delayed messaging mode; and while operating in the delayed messaging mode: composing a first message; and composing a second message, wherein the first message and the second message are scheduled to be transmitted at a first predetermined time.

In accordance with some embodiments, a method is described. The method comprises: at a computer system that is in communication with a display generation component and one or more input devices: displaying, via the display generation component, a message transcript in a messaging user interface, wherein displaying the message transcript includes concurrently displaying: a first message section including one or more transmitted messages, wherein the one or more transmitted messages have a first visual representation; and a second message section including one or more delayed messages that are scheduled to be transmitted at a first predetermined time, wherein the one or more delayed messages have a second visual representation that is different from the first visual representation; and receiving, via the one or more input devices, a first set of one or more inputs to compose and transmit a first message; and in response to receiving the first set of one or more inputs: in accordance with a determination that the computer system is not operating in a delayed messaging mode, displaying the first message in the first message section with the first visual representation; and in accordance with a determination that the computer system is operating in a delayed messaging mode, displaying the first message in the second message section with the second visual representation.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: displaying, via the display generation component, a message transcript in a messaging user interface, wherein displaying the message transcript includes concurrently displaying: a first message section including one or more transmitted messages, wherein the one or more transmitted messages have a first visual representation; and a second message section including one or more delayed messages that are scheduled to be transmitted at a first predetermined time, wherein the one or more delayed messages have a second visual representation that is different from the first visual representation; and receiving, via the one or more input devices, a first set of one or more inputs to compose and transmit a first message; and in response to receiving the first set of one or more inputs: in accordance with a determination that the computer system is not operating in a delayed messaging mode, displaying the first message in the first message section with the first visual representation; and in accordance with a determination that the computer system is operating in a delayed messaging mode, displaying the first message in the second message section with the second visual representation.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: displaying, via the display generation component, a message transcript in a messaging user interface, wherein displaying the message transcript includes concurrently displaying: a first message section including one or more transmitted messages, wherein the one or more transmitted messages have a first visual representation; and a second message section including one or more delayed messages that are scheduled to be transmitted at a first predetermined time, wherein the one or more delayed messages have a second visual representation that is different from the first visual representation; and receiving, via the one or more input devices, a first set of one or more inputs to compose and transmit a first message; and in response to receiving the first set of one or more inputs: in accordance with a determination that the computer system is not operating in a delayed messaging mode, displaying the first message in the first message section with the first visual representation; and in accordance with a determination that the computer system is operating in a delayed messaging mode, displaying the first message in the second message section with the second visual representation.

In accordance with some embodiments, a computer system configured to communicate with a display generation component and one or more input devices is described. The computer system comprises one or more processors and memory storing one or more programs configured to be executed by the one or more processors. The one or more programs include instructions for: displaying, via the display generation component, a message transcript in a messaging user interface, wherein displaying the message transcript includes concurrently displaying: a first message section including one or more transmitted messages, wherein the one or more transmitted messages have a first visual representation; and a second message section including one or more delayed messages that are scheduled to be transmitted at a first predetermined time, wherein the one or more delayed messages have a second visual representation that is different from the first visual representation; and receiving, via the one or more input devices, a first set of one or more inputs to compose and transmit a first message; and in response to receiving the first set of one or more inputs: in accordance with a determination that the computer system is not operating in a delayed messaging mode, displaying the first message in the first message section with the first visual representation; and in accordance with a determination that the computer system is operating in a delayed messaging mode, displaying the first message in the second message section with the second visual representation.

In accordance with some embodiments, a computer system configured to communicate with a display generation component and one or more input devices is described. The computer system comprises: means for, means for displaying, via the display generation component, a message transcript in a messaging user interface, wherein displaying the message transcript includes concurrently displaying: a first message section including one or more transmitted messages, wherein the one or more transmitted messages have a first visual representation; and a second message section including one or more delayed messages that are scheduled to be transmitted at a first predetermined time, wherein the one or more delayed messages have a second visual representation that is different from the first visual representation; and means for receiving, via the one or more input devices, a first set of one or more inputs to compose and transmit a first message; and means for, in response to receiving the first set of one or more inputs: in accordance with a determination that the computer system is not operating in a delayed messaging mode, displaying the first message in the first message section with the first visual representation; and in accordance with a determination that the computer system is operating in a delayed messaging mode, displaying the first message in the second message section with the second visual representation.

In accordance with some embodiments, a computer program product is described. The computer program product comprises one or more programs configured to be executed by one or more processors of a computer system that is in communication with a display generation component and one or more input devices. The one or more programs include instructions for: displaying, via the display generation component, a message transcript in a messaging user interface, wherein displaying the message transcript includes concurrently displaying: a first message section including one or more transmitted messages, wherein the one or more transmitted messages have a first visual representation; and a second message section including one or more delayed messages that are scheduled to be transmitted at a first predetermined time, wherein the one or more delayed messages have a second visual representation that is different from the first visual representation; and receiving, via the one or more input devices, a first set of one or more inputs to compose and transmit a first message; and in response to receiving the first set of one or more inputs: in accordance with a determination that the computer system is not operating in a delayed messaging mode, displaying the first message in the first message section with the first visual representation; and in accordance with a determination that the computer system is operating in a delayed messaging mode, displaying the first message in the second message section with the second visual representation.

In accordance with some embodiments, a method is described. The method comprises: at a computer system that is in communication with a display generation component and one or more input devices: displaying, via the display generation component and in a messaging user interface, a first preview of a first message that includes a link to a first source; while displaying the first preview, receiving, via the one or more input devices, a first set of one or more inputs; and in response to receiving the first set of one or more inputs, displaying a first user interface for customizing a respective visual representation of the first message, wherein the respective visual representation of the first message is indicative of a visual representation of the first message as it would be displayed on a receiving external device upon transmission of the first message to the receiving external device.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: displaying, via the display generation component and in a messaging user interface, a first preview of a first message that includes a link to a first source; while displaying the first preview, receiving, via the one or more input devices, a first set of one or more inputs; and in response to receiving the first set of one or more inputs, displaying a first user interface for customizing a respective visual representation of the first message, wherein the respective visual representation of the first message is indicative of a visual representation of the first message as it would be displayed on a receiving external device upon transmission of the first message to the receiving external device.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: displaying, via the display generation component and in a messaging user interface, a first preview of a first message that includes a link to a first source; while displaying the first preview, receiving, via the one or more input devices, a first set of one or more inputs; and in response to receiving the first set of one or more inputs, displaying a first user interface for customizing a respective visual representation of the first message, wherein the respective visual representation of the first message is indicative of a visual representation of the first message as it would be displayed on a receiving external device upon transmission of the first message to the receiving external device.

In accordance with some embodiments, a computer system configured to communicate with a display generation component and one or more input devices is described. The computer system comprises one or more processors and memory storing one or more programs configured to be executed by the one or more processors. The one or more programs include instructions for: displaying, via the display generation component and in a messaging user interface, a first preview of a first message that includes a link to a first source; while displaying the first preview, receiving, via the one or more input devices, a first set of one or more inputs; and in response to receiving the first set of one or more inputs, displaying a first user interface for customizing a respective visual representation of the first message, wherein the respective visual representation of the first message is indicative of a visual representation of the first message as it would be displayed on a receiving external device upon transmission of the first message to the receiving external device.

In accordance with some embodiments, a computer system configured to communicate with a display generation component and one or more input devices is described. The computer system comprises: means for displaying, via the display generation component and in a messaging user interface, a first preview of a first message that includes a link to a first source; means for, while displaying the first preview, receiving, via the one or more input devices, a first set of one or more inputs; and means for, in response to receiving the first set of one or more inputs, displaying a first user interface for customizing a respective visual representation of the first message, wherein the respective visual representation of the first message is indicative of a visual representation of the first message as it would be displayed on a receiving external device upon transmission of the first message to the receiving external device.

In accordance with some embodiments, a computer program product is described. The computer program product comprises one or more programs configured to be executed by one or more processors of a computer system that is in communication with a display generation component and one or more input devices. The one or more programs include instructions for: displaying, via the display generation component and in a messaging user interface, a first preview of a first message that includes a link to a first source; while displaying the first preview, receiving, via the one or more input devices, a first set of one or more inputs; and in response to receiving the first set of one or more inputs, displaying a first user interface for customizing a respective visual representation of the first message, wherein the respective visual representation of the first message is indicative of a visual representation of the first message as it would be displayed on a receiving external device upon transmission of the first message to the receiving external device.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for composing messages, thereby increasing the effectiveness, efficiency, and user satisfaction with such devices. Such methods and interfaces may complement or replace other methods for composing messages.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6Z illustrate exemplary methods for composing messages in a delayed messaging mode and/or displaying delayed messages in a message transcript, in accordance with some embodiments.

FIG. 7 is a flow diagram illustrating a method for composing messages in a delayed messaging mode in accordance with some embodiments.

FIG. 8 is a flow diagram illustrating a method for displaying delayed messages in a message transcript in accordance with some embodiments.

FIGS. 9A-9K illustrate exemplary methods for customizing the visual representation of linked messages in a messaging session, in accordance with some embodiments.

FIG. 10 is a flow diagram illustrating a method for customizing the visual representation of linked messages in a messaging session in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for composing messages. For example, there is a need for computer systems that compose messages in a delayed messaging mode, such that the user can compose multiple messages to be transmitted at a future time without having to individually program a delayed delivery time for individual messages. There is also a need for computers systems that display delayed messages in a message transcript to provide a visual indication to the user that certain messages are scheduled to be transmitted at a later time. There is also a need for a computer system that customizes the visual representation of linked messages before transmission to provide visual confirmation to the user that the visual representation being customized will reflect the visual representation of the message that is ultimately sent. Such techniques can reduce the cognitive burden on a user who composes messages in various user interfaces, thereby enhancing productivity. Further, such techniques can reduce processor and battery power otherwise wasted on redundant user inputs.

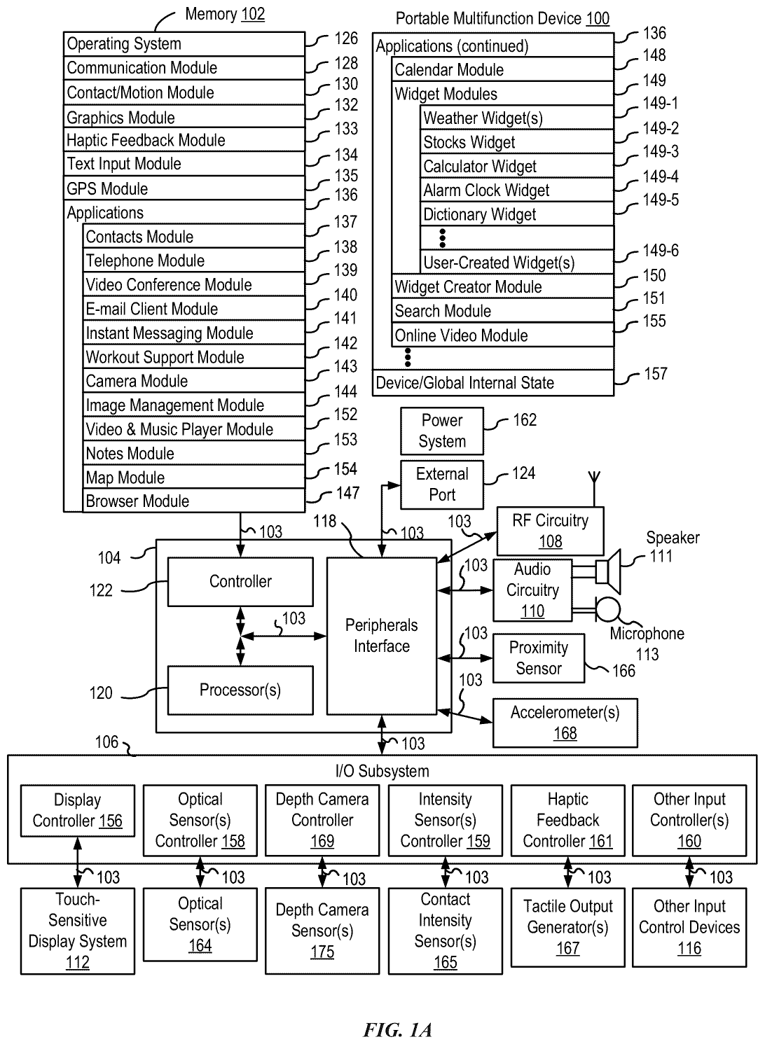

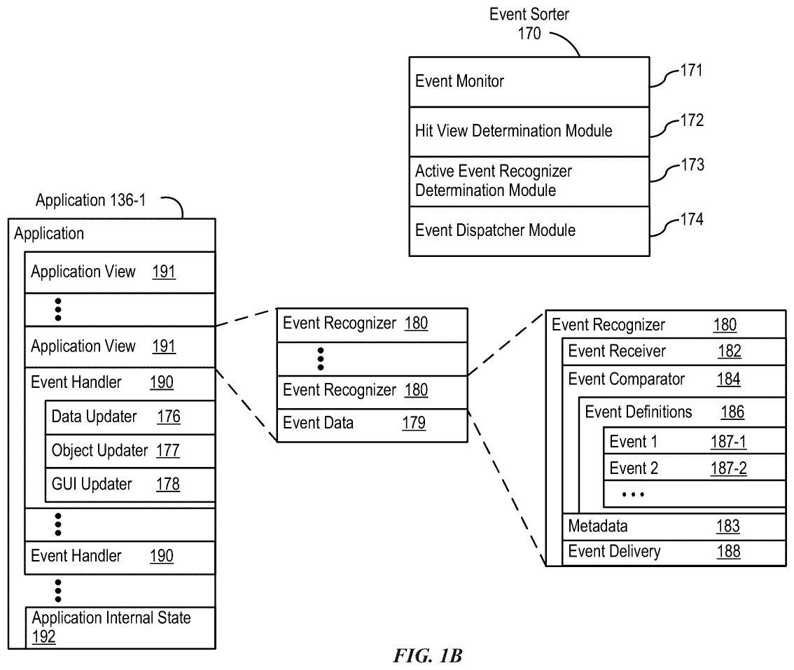

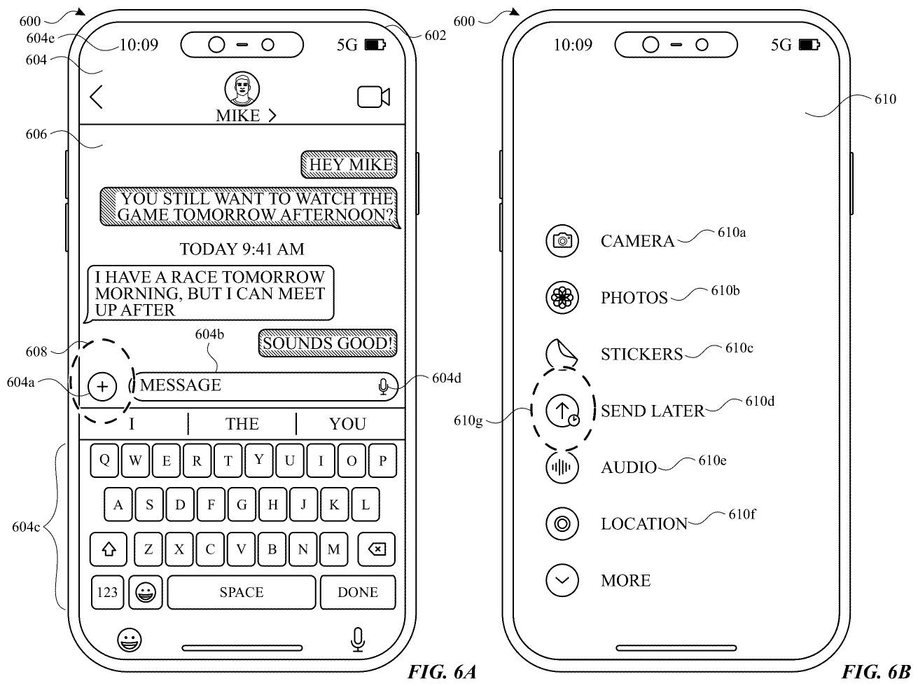

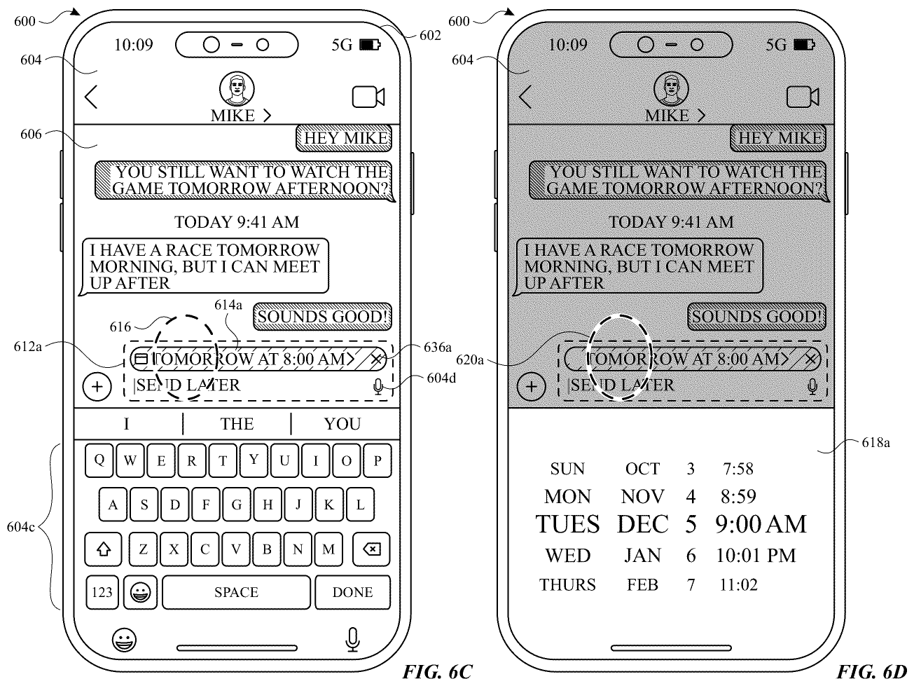

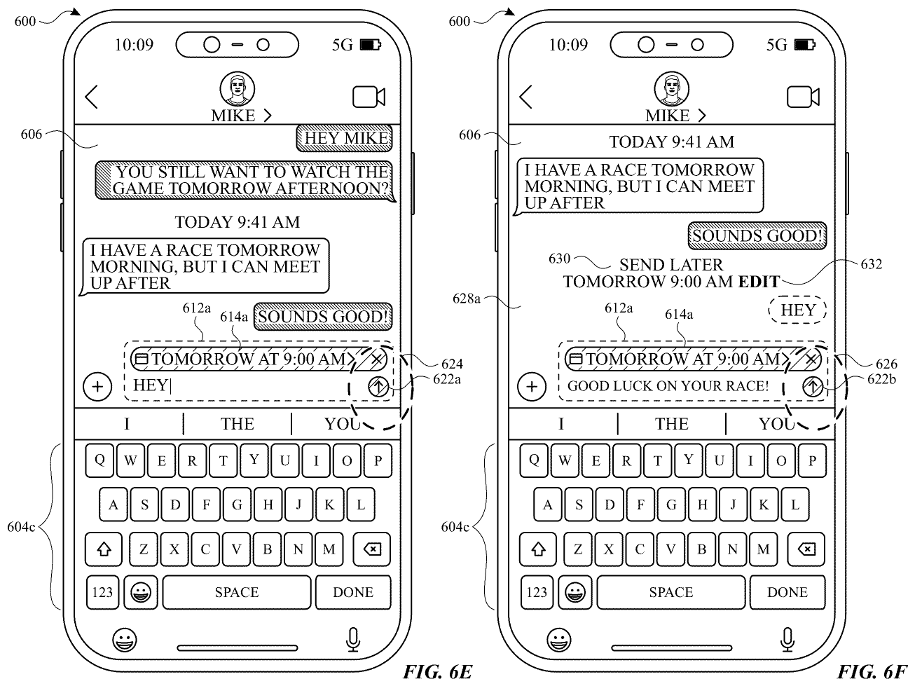

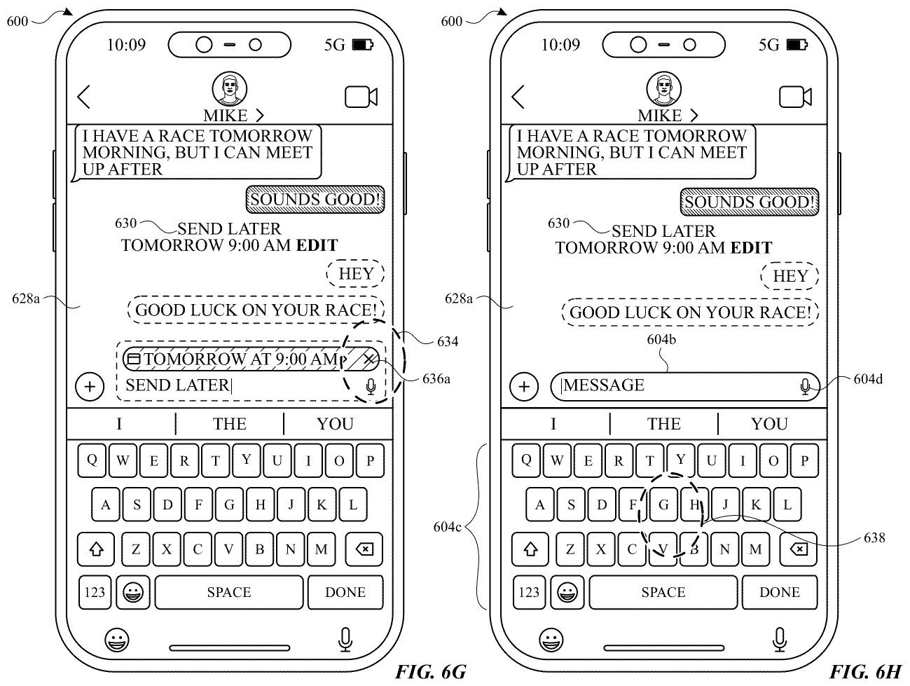

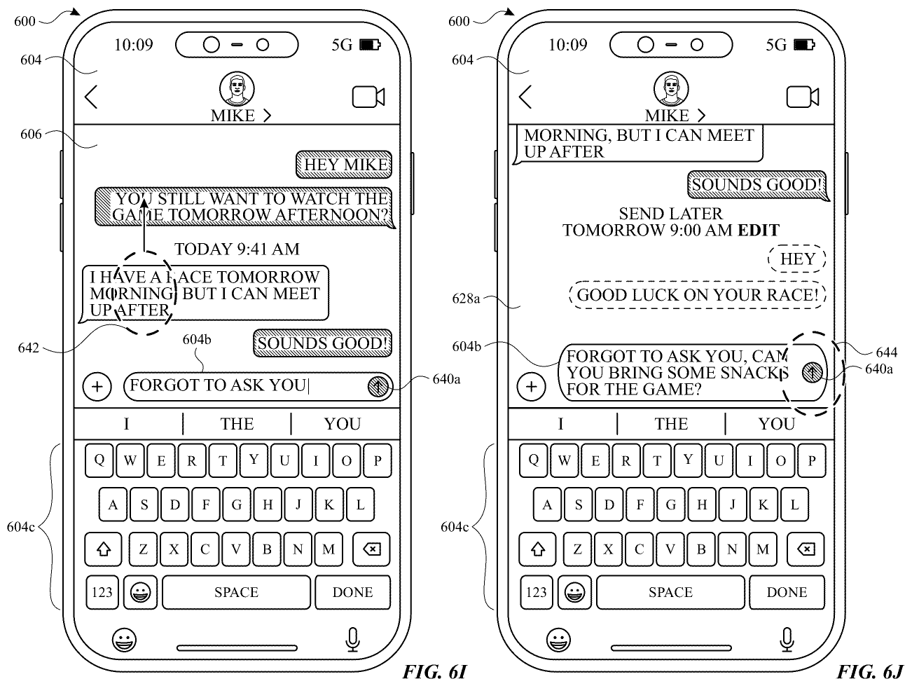

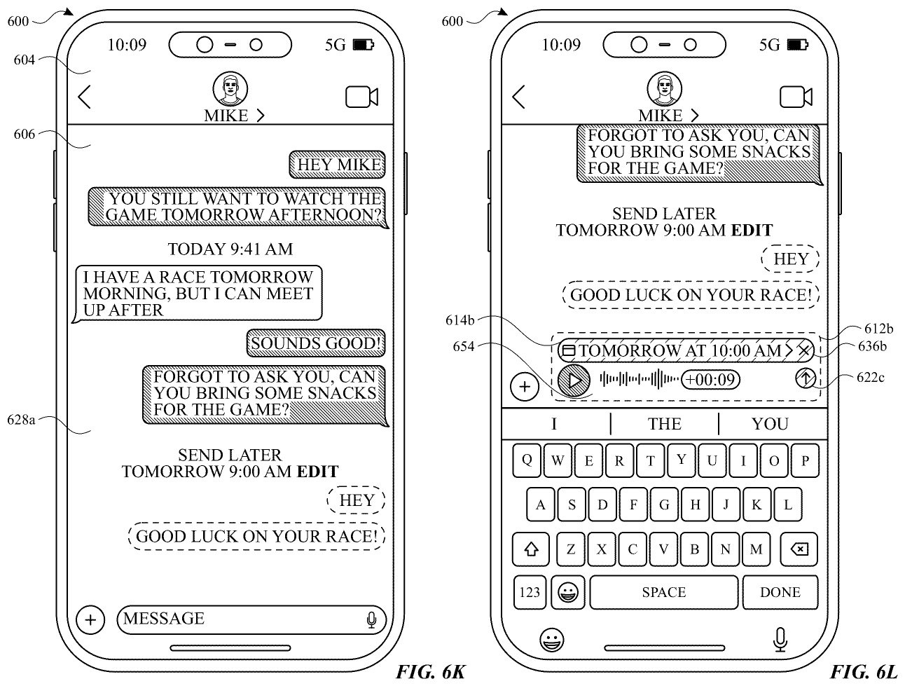

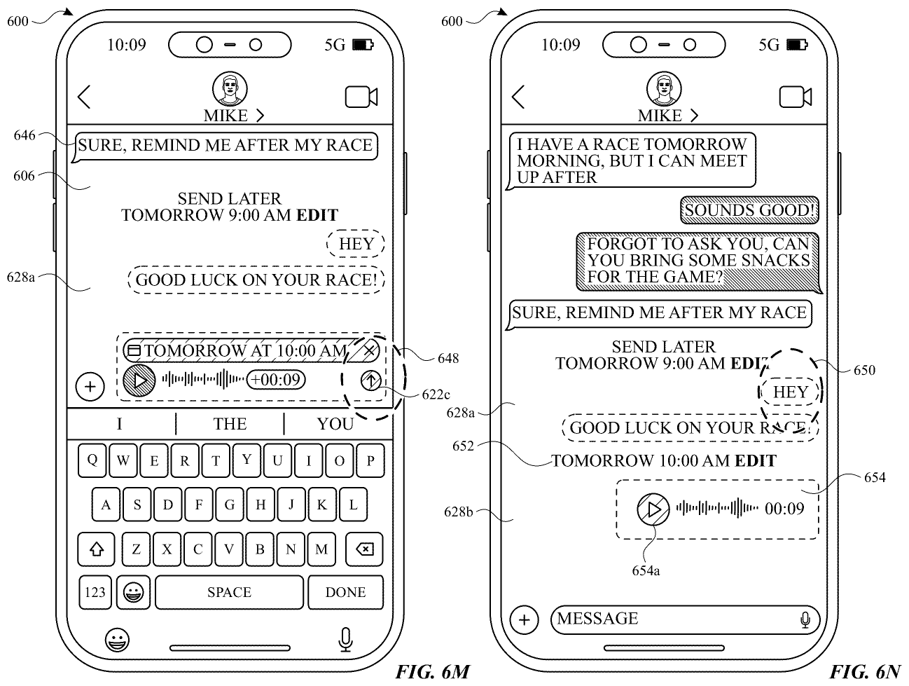

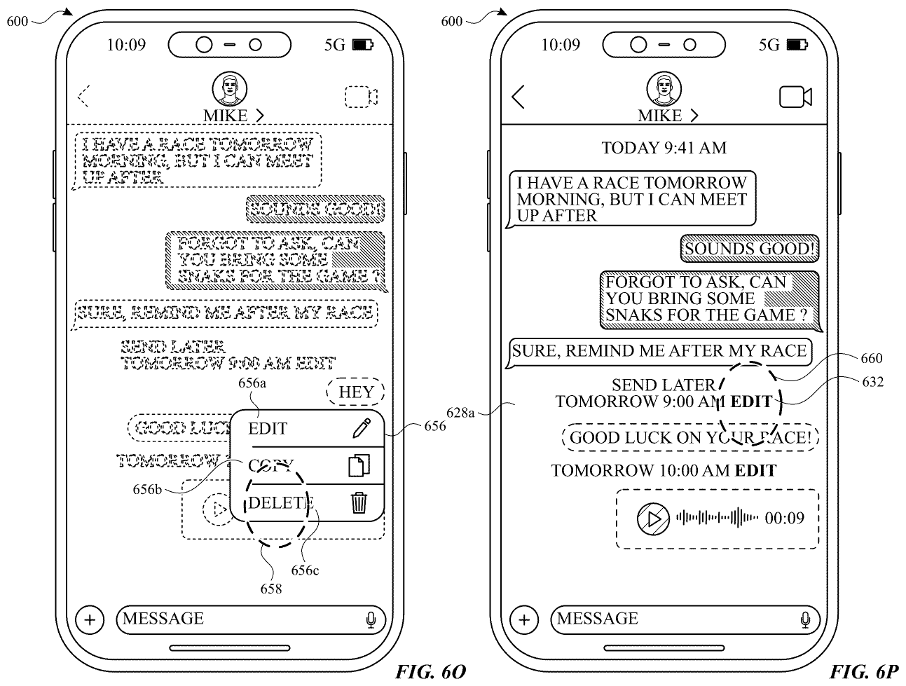

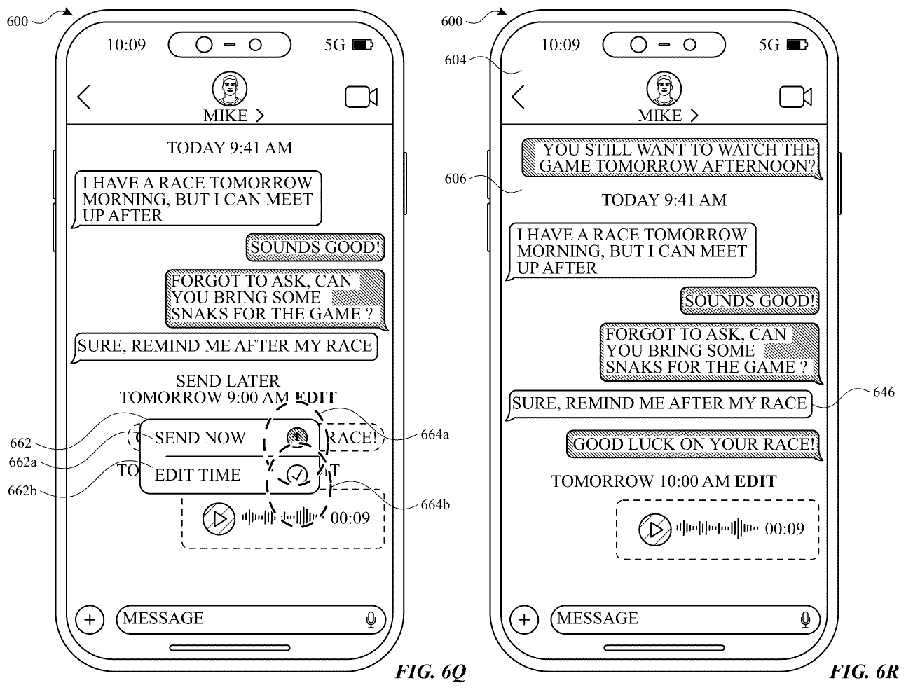

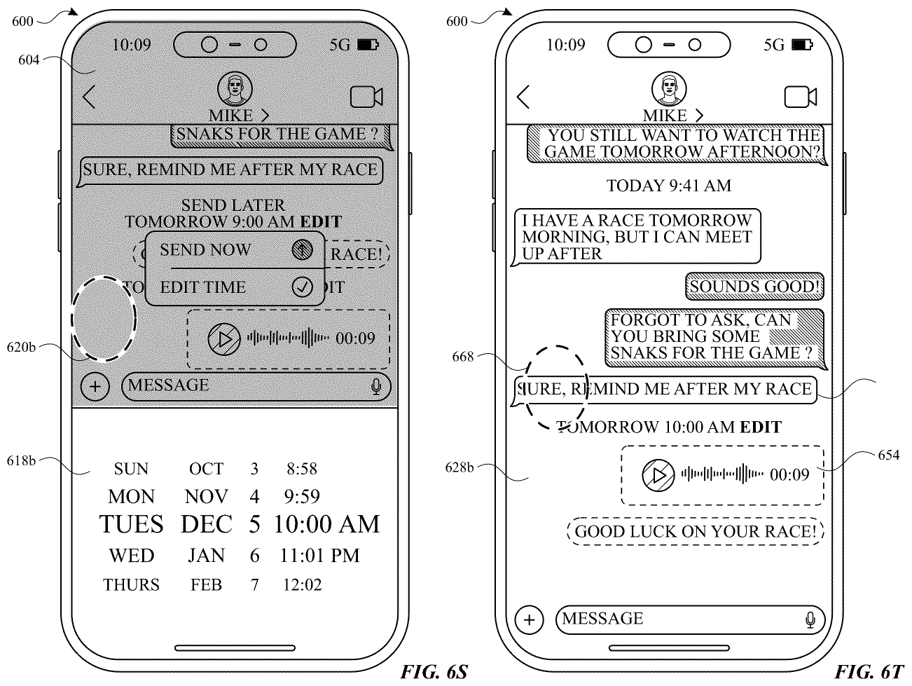

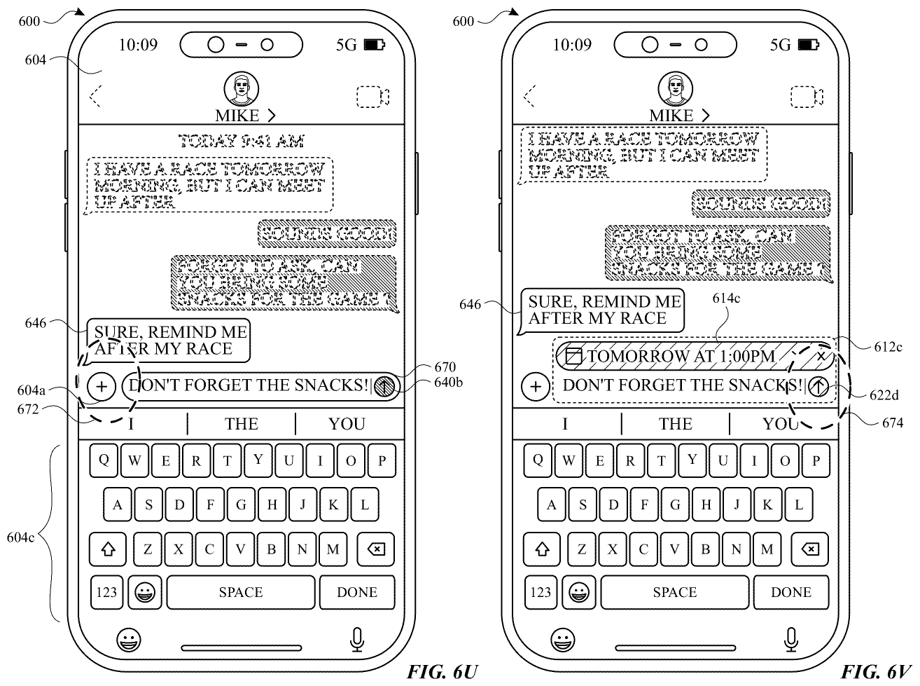

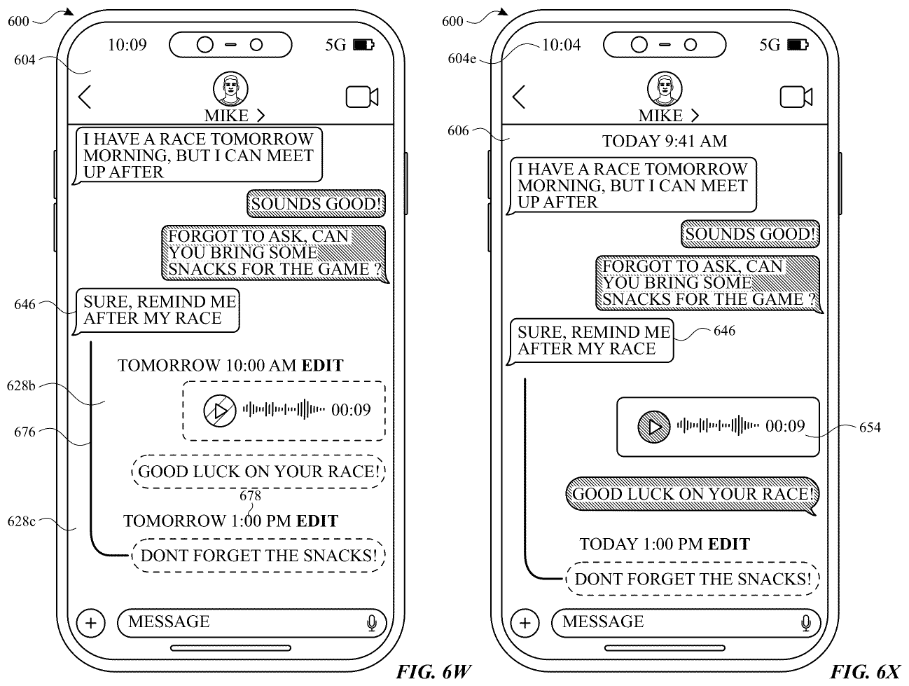

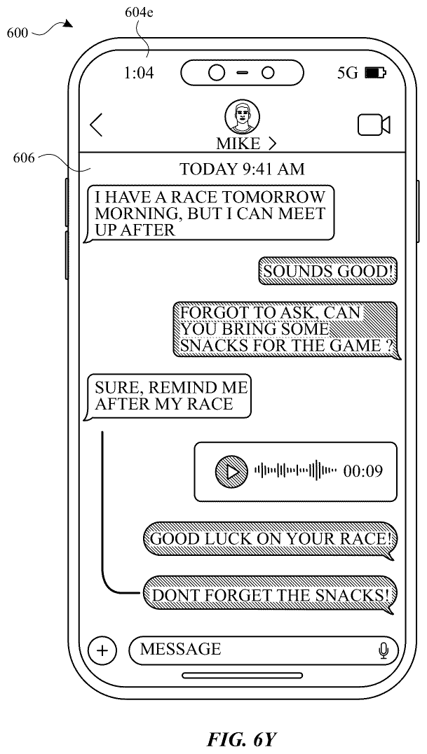

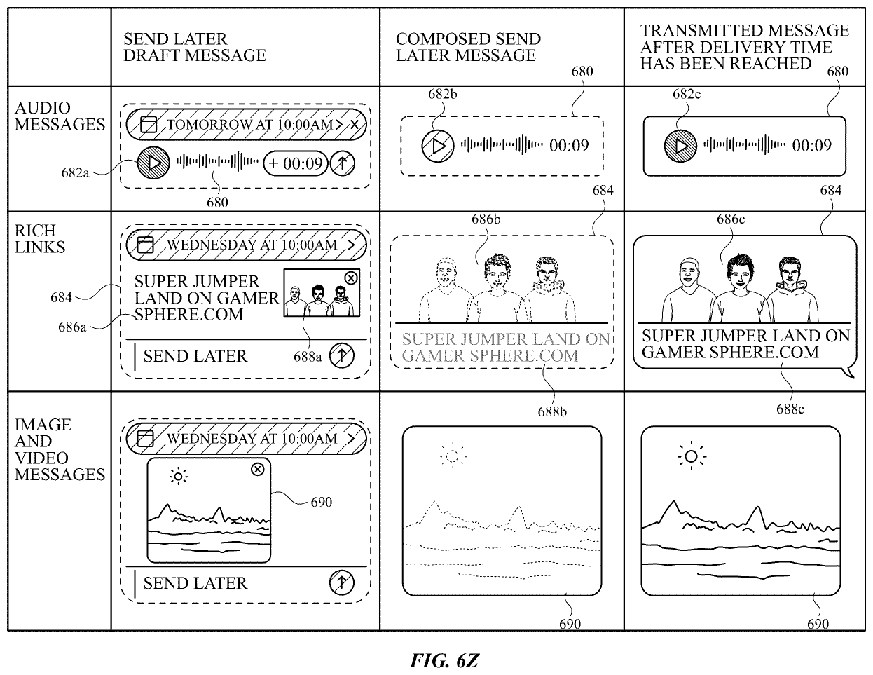

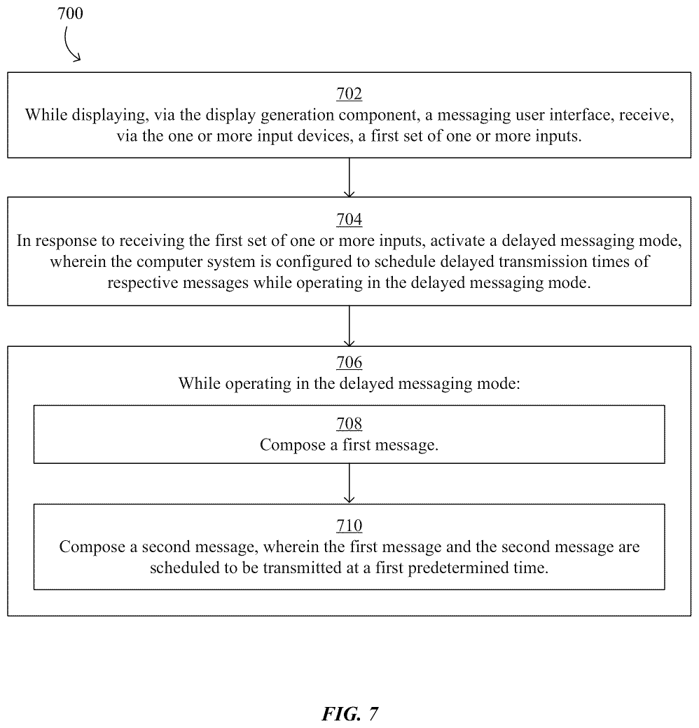

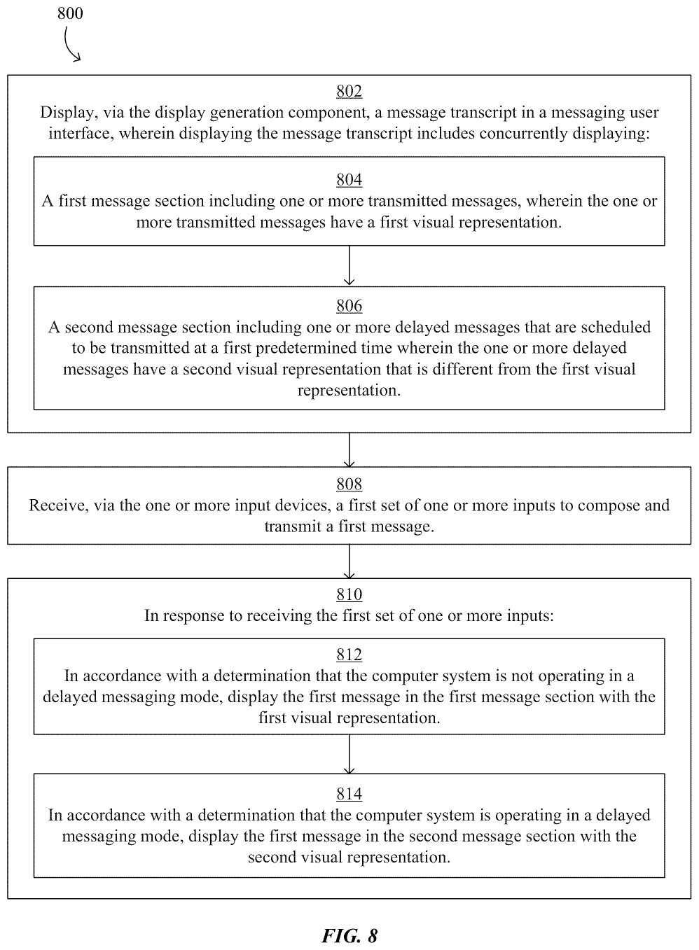

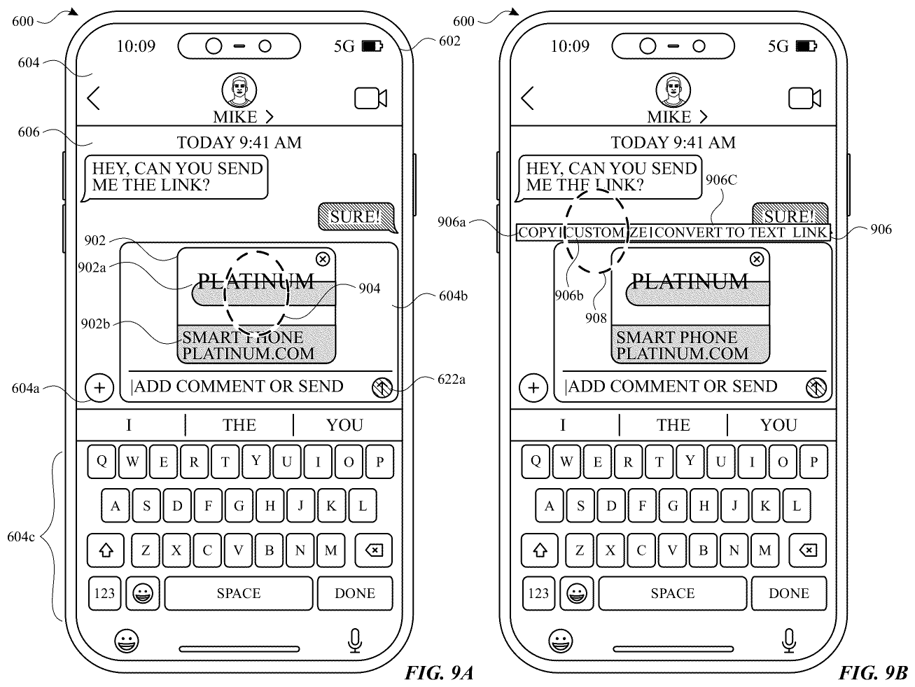

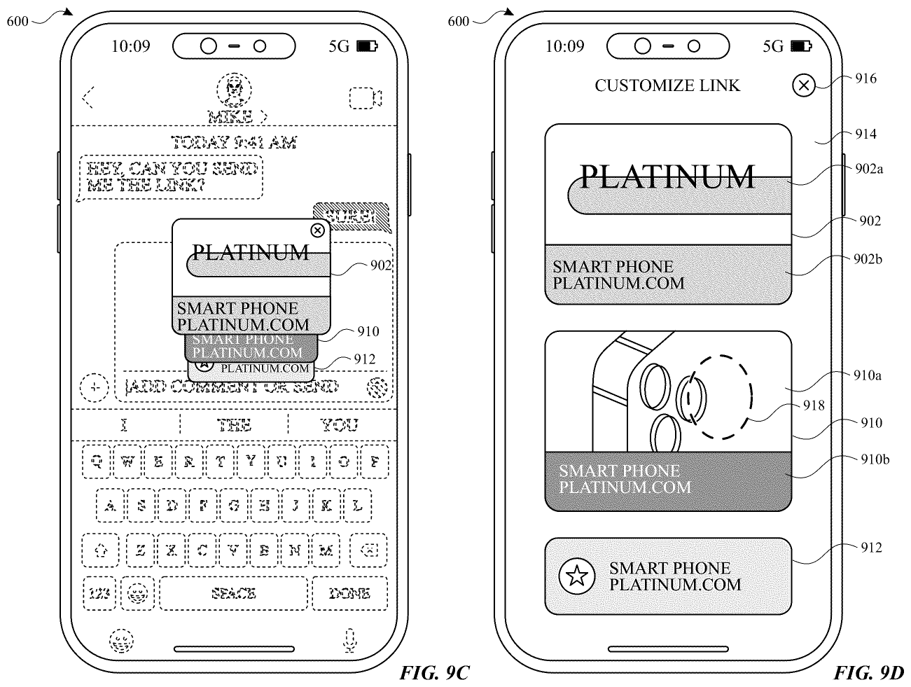

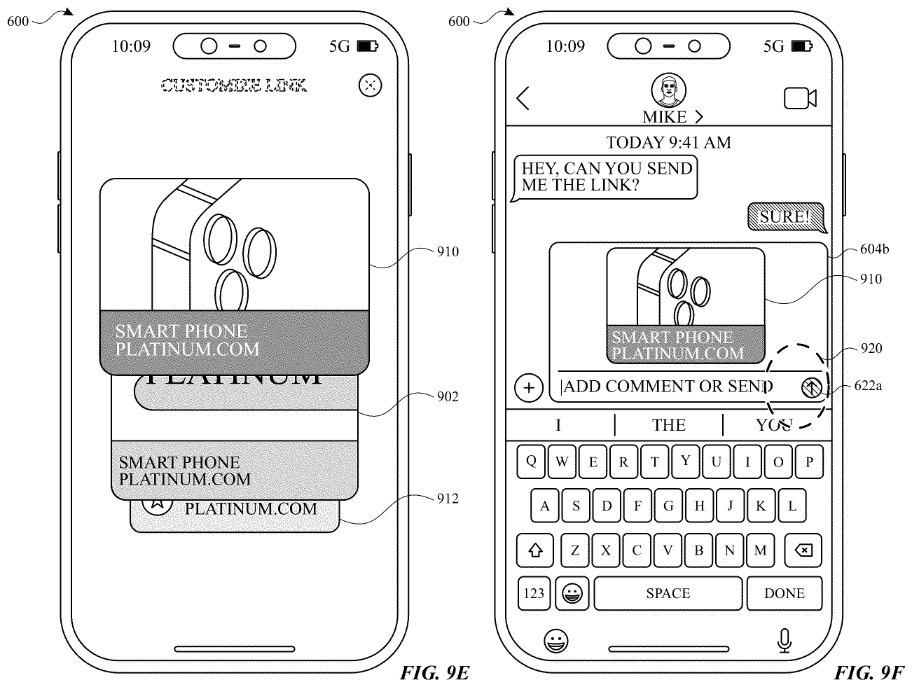

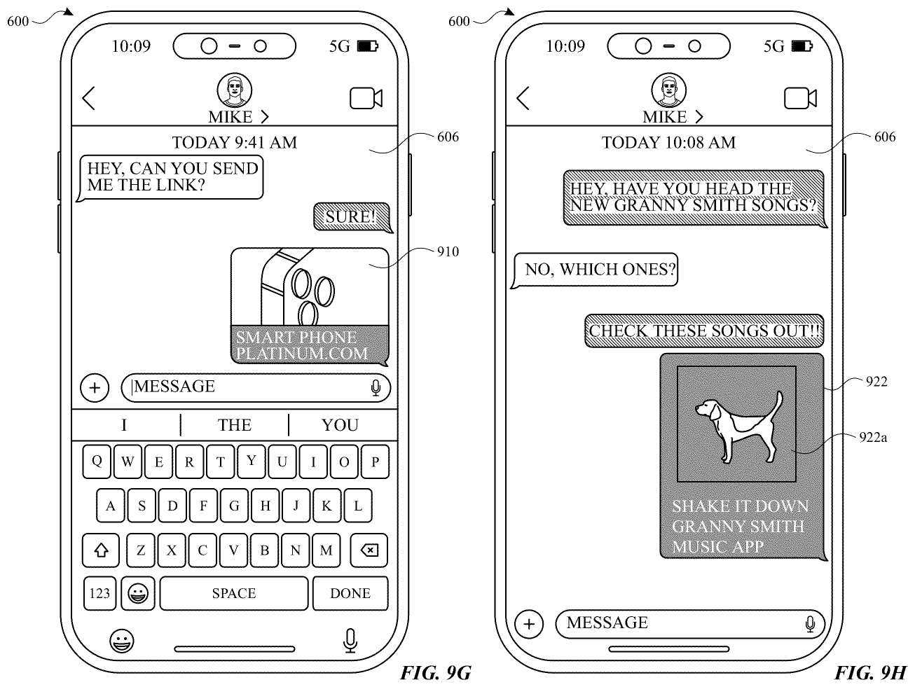

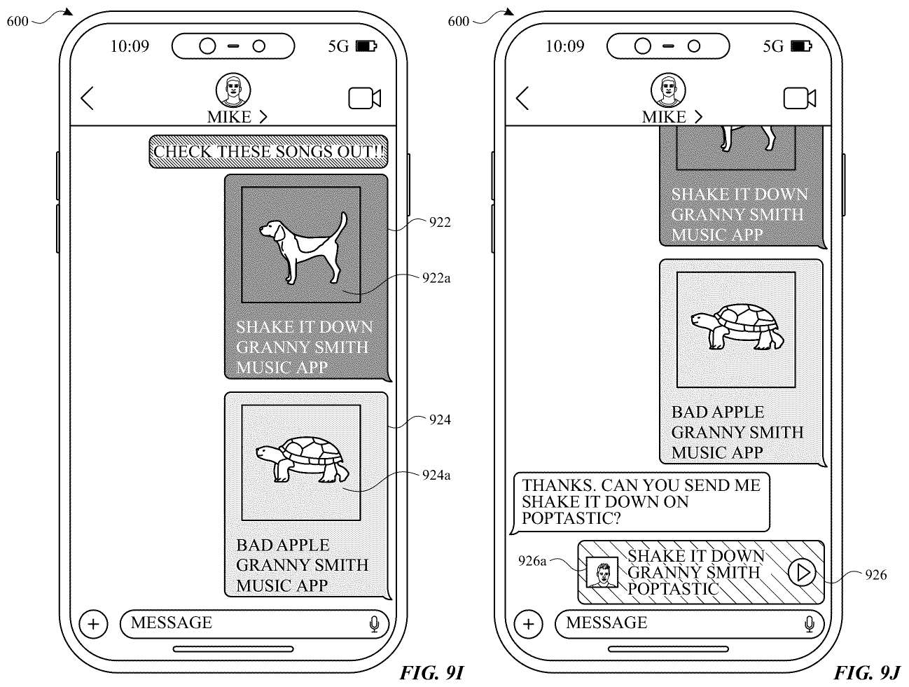

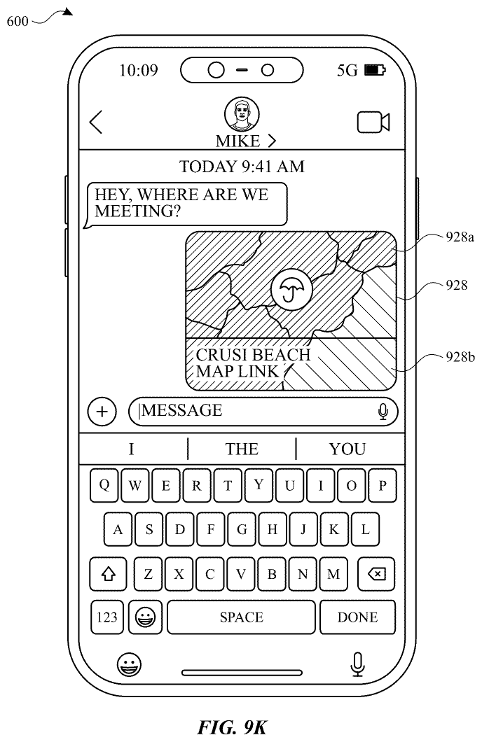

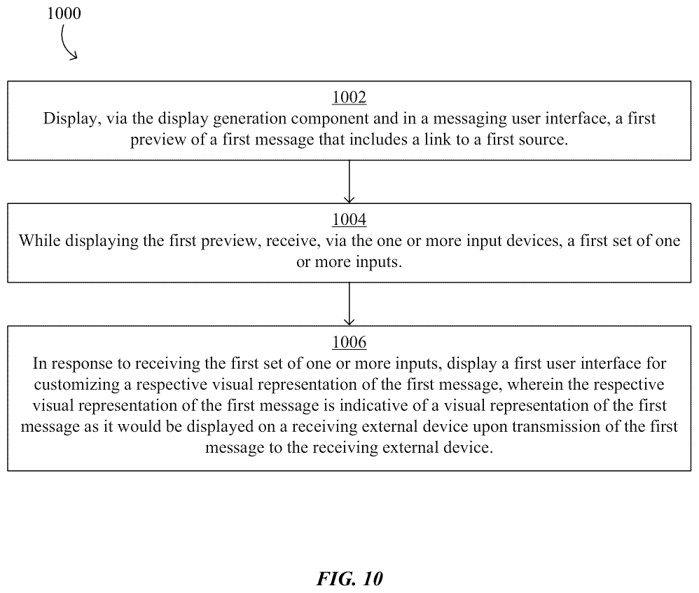

Below, FIGS. 1A-1B, 2, 3A-3G, 4A-4B, and 5A-5B provide a description of exemplary devices for performing the techniques for composing messages in various user interfaces. FIGS. 6A-6Z illustrate exemplary methods for composing messages in a delayed messaging mode and/or displaying delayed messages in a message transcript. FIG. 7 is a flow diagram illustrating a method for composing messages in a delayed messaging mode. FIG. 8 is a flow diagram illustrating a method for displaying delayed messages in a message transcript. The user interfaces in FIGS. 6A-6Z are used to illustrate the process described below, including the processes in FIGS. 7 and 8. FIGS. 9A-9K illustrate exemplary methods for customizing the visual representation of linked messages in a messaging session, in accordance with some embodiments. FIG. 10 is a flow diagram illustrating a method for customizing the visual representation of linked messages in a messaging session in accordance with some embodiments The user interfaces in FIGS. 9A-9K are used to illustrate the processes described below, including the process in FIG. 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (H SUPA), E volution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

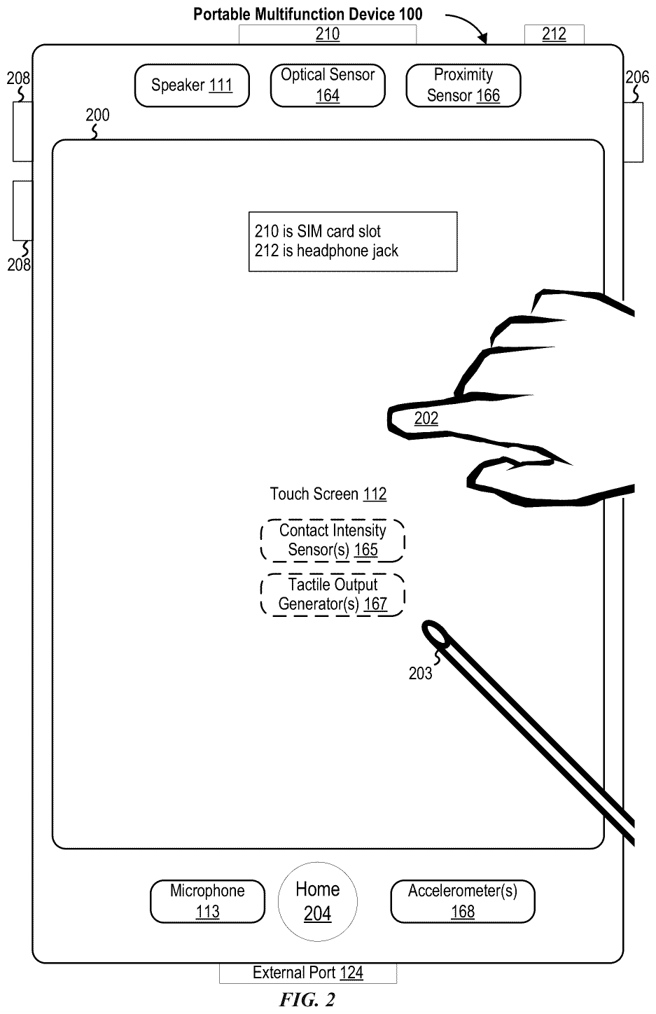

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

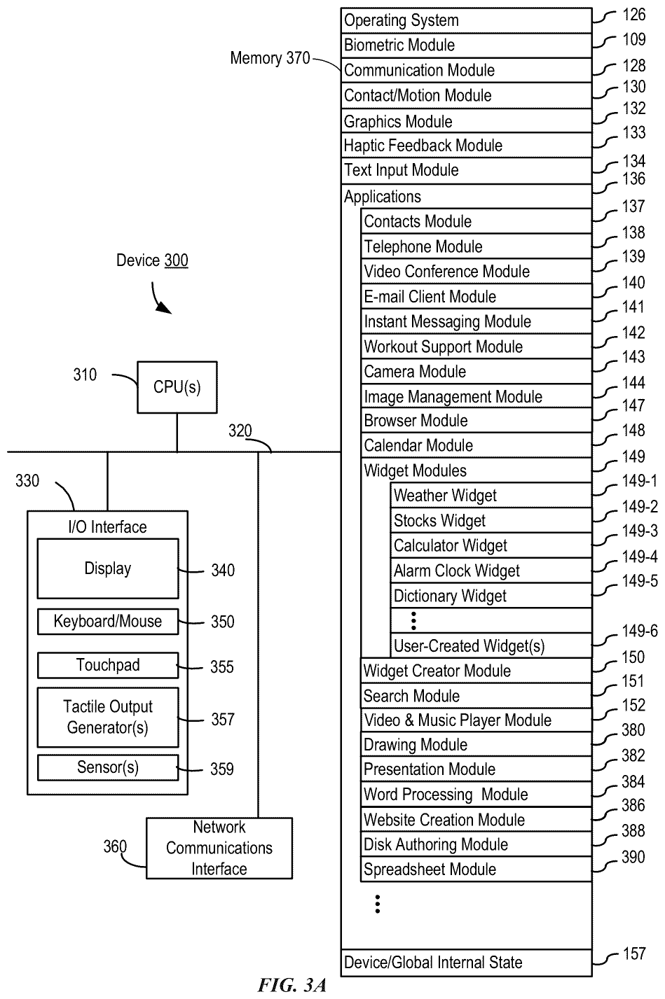

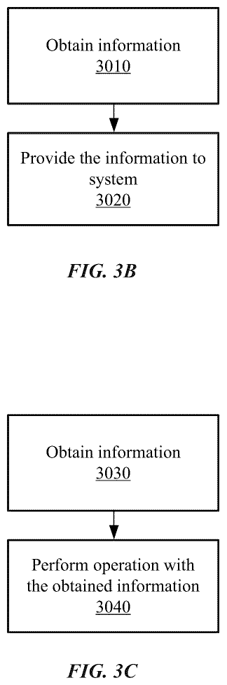

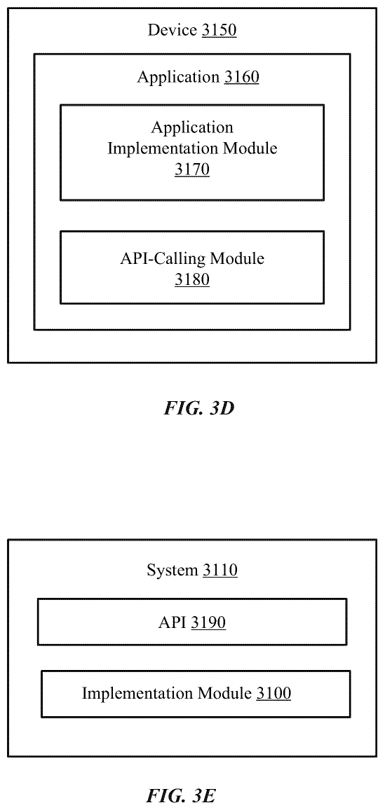

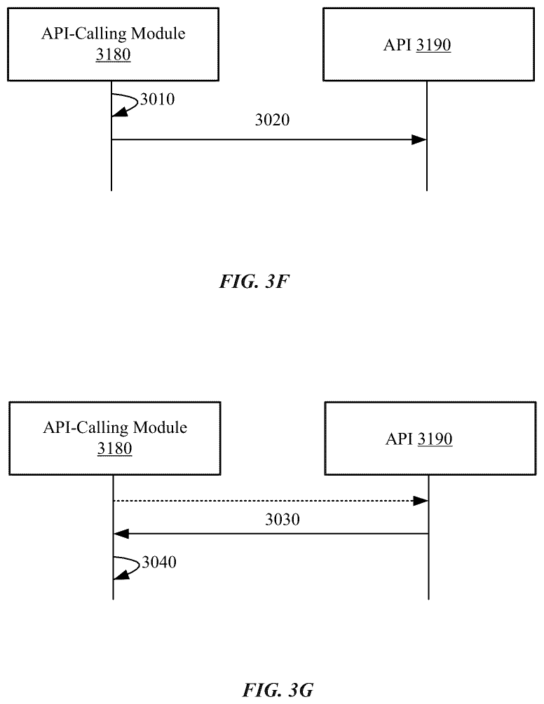

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
M ap module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IM U (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. M any of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 800, and/or 1000 (FIGS. 7, 8, and/or 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

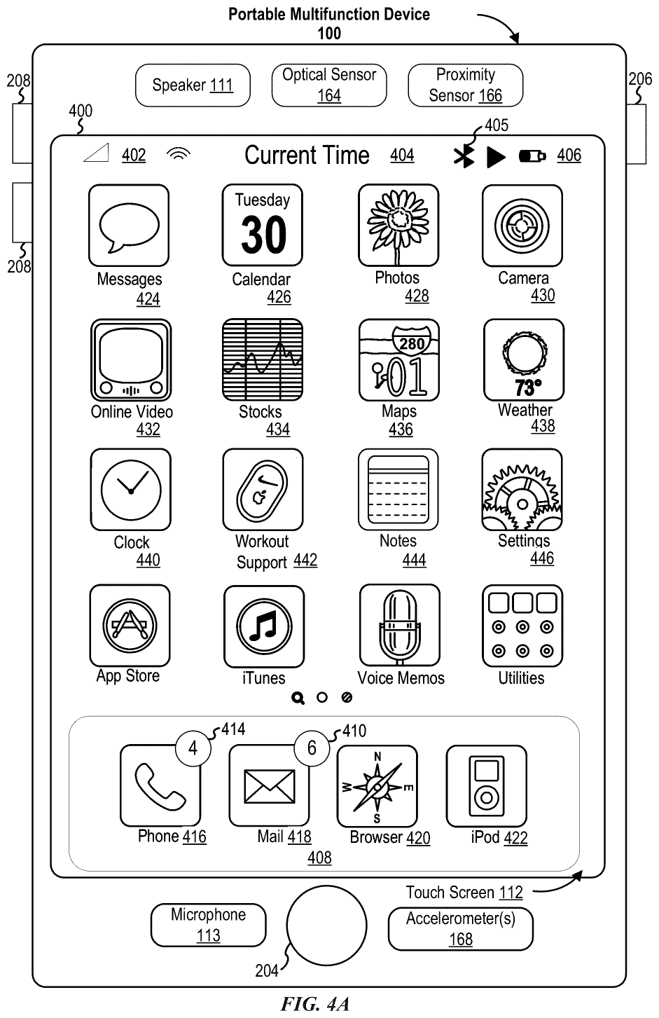

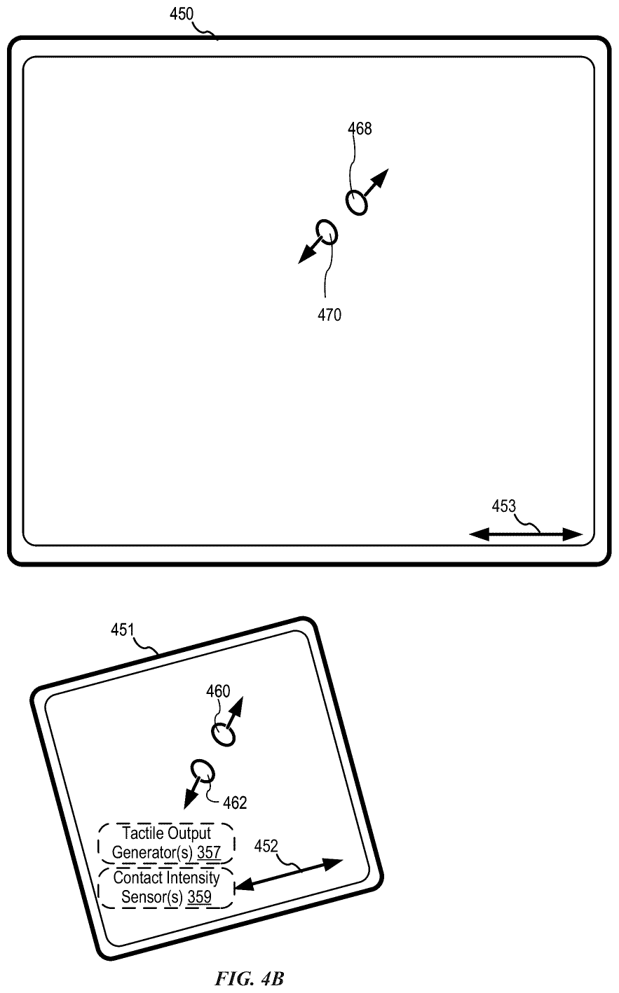

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

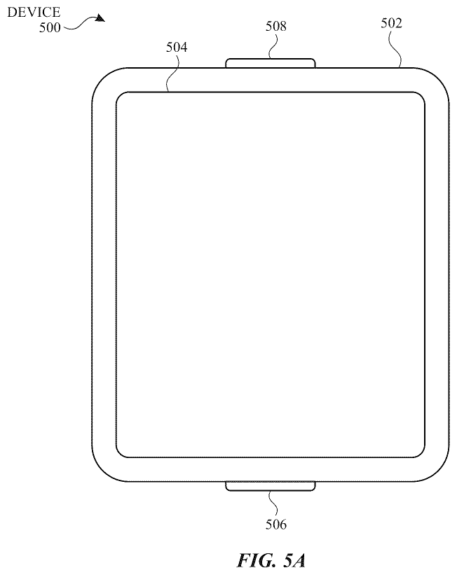

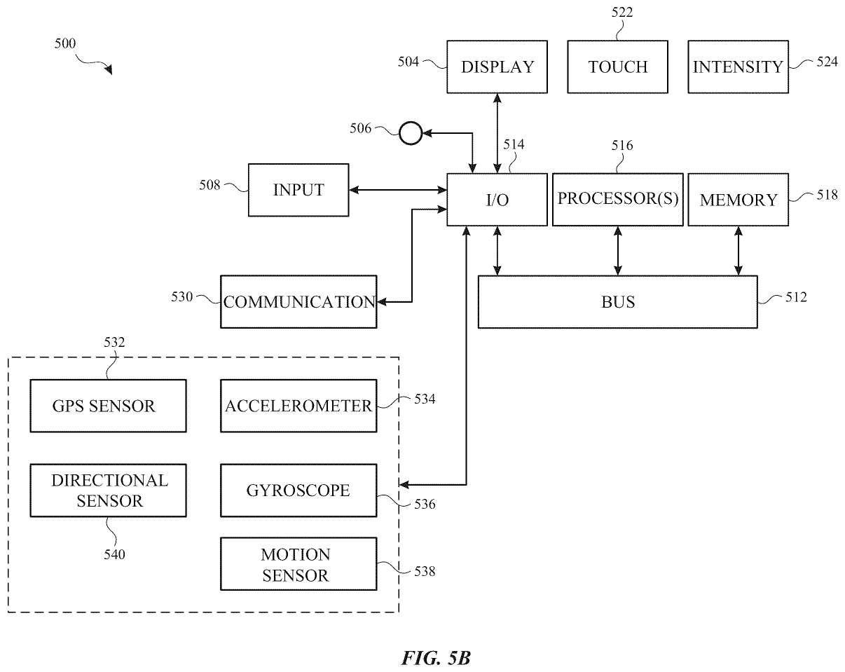

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 800 (FIGS. 6A-6Z), and 1000 (FIGS. 9A-9K). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6Z illustrate exemplary methods for composing messages in a delayed messaging mode and/or displaying delayed messages in a message transcript, in accordance with some embodiments. The user interfaces in these figures are used to illustrate the processes described below, including the processes in FIG. 7 and FIG. 8.

FIG. 6A illustrates computer system 600, which is a smart phone with touch-sensitive display 602. Although the depicted embodiments show an example in which computer system 600 is a smart phone. In other embodiments, computer system 600 is a different type of computer system (e.g., a tablet, a laptop computer, a desktop computer, a wearable device, and/or a headset). In some embodiments, computer system 600 includes one or more features of device 100, 300, and/or 500. At FIG. 6A, computer system 600 displays messaging user interface 604. Messaging user interface 604 corresponds to a messaging session between a user of computer system 600 and one or more other users (e.g., “Mike”). Messaging user interface 604 includes message region 606, which displays one or more messages that have been transmitted into the messaging session by the user of the computer system and the one or more other users. Messages transmitted by the user of computer system 600 are displayed on a right side of message region 606, and messages that have been transmitted by the other users and received by computer system 600 are displayed on a left side of message region 606. Messaging user interface 604 also includes messaging menu icon 604a, text field 604b, keyboard 604c, audio-to-text icon 604d, and current time indicator 604e. Text field 604b displays text entered by the user (e.g., via keyboard 604c and/or via spoken input) and to be transmitted into the messaging session. Option 604d, when selected, causes computer system 600 to receive audio input (e.g., spoken input) and to convert the audio input into text to be displayed within text field 604b. Current time indicator 604e represents the current time (e.g., “10:09” which represents 10:09 AM on Monday December 4) derived from a world clock in communication with computer system 600. In some embodiments, text field 604b is displayed with a solid border indicating that the computer system is operating in a mode where text messages are transmitted immediately upon completion and/or sending. At FIG. 6A, computer system 600 detects user input 608 (e.g., a tap input) directed towards messaging menu icon 604a. In some embodiments, user input 608, and other user inputs described in FIGS. 6A-6Z, can be a touch input (e.g., a tap input, long press input, and/or a swipe input), an air gesture, and/or a gaze-based input.

At FIG. 6B, in response to user input 608, computer system 600 displays messaging menu interface 610. Additionally, at FIG. 6B, in response to user input 608, computer system 600 replaces the display of messaging user interface 604 with messaging menu interface 610. In some embodiments, messaging user interface 610 includes camera option 610a, photos option 610b, stickers option 610c, send later option 610d, audio message option 610e, and live location option 610f. At FIG. 6B, computer system 600 detects user input 610g (e.g., a tap input) corresponding to send later mode option 610d.

At FIG. 6C, in response to user input 610g, computer system 600 redisplays messaging user interface 604. Additionally, at FIG. 6C, in response to user input 610g, computer system 600 begins operating in a send later mode (e.g., a mode where messages can be composed with a delayed transmission time) and displays send later text field 612a in place of text field 604b (e.g., as shown in FIG. 6A). Send later text field 612a is displayed with a dashed border indicating that the computer system is operating in a send later mode, in which messages can be composed with a delayed transmission time. Send later text field 612a additionally includes delivery time indicator 614a, which indicates the time in which a composed message will be transmitted (e.g., “Tomorrow at 8:00 AM”), and send later cancellation icon 636a, which can be selected to exit the send later mode (e.g., replace send later text field 612a with text field 604b). In some embodiments, “Tomorrow at 8:00 AM” is a default time that is automatically selected (e.g., based on the frequency at which the user of computer system 600 selects “Tomorrow at 8:00 AM” as a delayed message delivery time while drafting messages in the send later mode) and displayed by the computer system. At FIG. 6C, computer system 600 detects user input 616 (e.g., a tap input) corresponding to delivery time indicator 614a.

At FIG. 6D, in response to user input 616, computer system 600 displays delivery time selection interface 618a. In some embodiments, in response to user input 616, computer system 600 replaces keyboard 604c with delivery time selection interface 618a and dims (e.g., reduces the brightness of the display) the remaining portion of the messaging interface 604. In some embodiments, delayed delivery time interface 618a displays a scrollable list (e.g., a selection wheel) of different future delivery times that can be selected via one or more swipe inputs corresponding to delivery time selection interface 618a. At FIG. 6D, “Tues December 5 9:00 AM” is displayed at the center of the scrollable list and in a larger font than the other delivery time options, which represents the delivery time that is prepared for selection by the user. At FIG. 6D, computer system 600 detects input 620a (e.g., a tap input) corresponding to messaging user interface 604. In some embodiments, input 620 can be anywhere on messaging user interface 604. In some embodiments, input 620 is directed to the delivery time that is prepared for selection (e.g., “Tues December 5 9:00 AM”) in delivery time selection interface 618a.

At FIG. 6E, in response to input 620a, computer system 600 replaces “Tomorrow at 8:00 A” with “Tomorrow at 9:00 AM” in delivery time indicator 612a. At FIG. 6E, computer system 600 displays message “Hey” as a drafted message (e.g., a message that has not been transmitted or scheduled to be transmitted) in send later text field 612a (e.g., in response to one or more inputs interacting with keyboard 604c or audio-to-text icon 604d). In some embodiments, after displaying message “Hey” in send later text field 612a, computer system 600 replaces audio-to-text icon 604d with send later send icon 622a. In some embodiments, send later send icon 622a is displayed as a blue arrow within a transparent (e.g., white) circle, indicating that message “Hey” will be sent with a delayed delivery time (e.g., “Tomorrow at 9:00 AM”). At FIG. 6E, computer system 600 detects user input 624 corresponding to send later send icon 622a.

At FIG. 6F, in response to input 624, computer system 600 displays message region 628a under message region 606 in messaging user interface 604. Message region 628a includes one or more messages that have been scheduled to be transmitted into the messaging session at a future scheduled time. Additionally, in response to input 624, computer system 600 displays message “Hey” as a composed message (e.g., a message that has been transmitted or scheduled to be transmitted) in message region 628. In some embodiments, message “Hey” is displayed with a dashed border and transparent background indicating that message “Hey” is a message with a delayed transmission time. In some embodiments, message “Hey” is displayed under send later header 630, which is also displayed in message region 628a. In some embodiments, send later header 630 identifies one or messages (e.g., including message “Hey”) that have a common delayed transmission time (e.g. “Tomorrow 9:00 AM”) in message section 628. In some embodiments, send later header 630 includes send later editing icon 632, which enables a user to edit the transmission time of the one or more messages (e.g., “Hey” and “Good luck on your race!” as shown in FIG. 6G) in message region 628a.

Continuing the example in FIG. 6F, computer system continues to operate in the send later mode and displays message “Good luck on your race!” as a drafted message in send later text field 612a (e.g., in response to one or more inputs interacting with keyboard 604c). Additionally, delivery time indicator 614a continues to be displayed with “Tomorrow at 9:00 AM”. At FIG. 6F, computer system 600 detects user input 626 corresponding to send later send icon 622b.

At FIG. 6G, in response to receiving input 626, computer system 600 displays “Good luck on your race!” as a composed message in message region 628a. In some embodiments, message “Good luck on your race”, is displayed in the same manner as message “Hey” (e.g., with a dashed border and transparent background) and is displayed under both message “Hey” and send later header 630, indicating that message “Good luck on your race” has the same future scheduled transmission time (e.g., “Tomorrow 9:00 AM”) as message “Hey”. At FIG. 6G, computer system 600 detects user input 634 (e.g., a tap input) corresponding to send later cancellation icon 636a.

At FIG. 6H, in response to user input 634, computer system 600 ceases operating in the send later mode and replaces the display of send later text field 612a with text field 604b. As shown in FIG. 6H, message “Hey” and message “Good luck on your race!” continue to be displayed in message region 628a under send later header 630. At FIG. 6H, computer system 600 detects user input 638 (e.g., one or more inputs interacting with keyboard 604c) to draft a new message in text field 604b.

At FIG. 6I, in response to user input 638, computer system 600 displays a first portion “Forgot to ask you . . . ” of full message “Forgot to ask you, can you bring some snacks for the game?” (e.g., as shown in FIG. 6J) in text field 604b. Additionally, in response to user input 638, computer system 600 shifts the position of message region 628a (e.g., underneath keyboard 604c) such that message “Hey” and message “Good luck on your race!” are no longer viewable in messaging interface 604. In some embodiments, after displaying first portion “Forgot to ask you . . . ” in text field 604b, computer system 600 replaces audio-to-text icon 604d (e.g., as shown in FIG. 6H) with send icon 640a. In some embodiments, send icon 640a is displayed as a white arrow within an opaque (e.g., blue) circle, indicating that a message drafted in text field 604b will be sent without a delayed delivery time (e.g., transmitted immediately upon sending). At FIG. 6I, computer system detects input 642 (e.g., an upward swipe input) corresponding to message region 606.

At FIG. 6J, in response to user input 642, computer system 600 redisplays message region 628a in messaging user interface 604. Additionally, at FIG. 6J, full message “Forgot to ask you, can you bring some snacks for the game?” is displayed text field 604b (e.g., in response to one or more inputs interacting with keyboard 604c). At FIG. 6J, computer system 600 detects user input 644 corresponding to send icon 640a.

At FIG. 6K, in response to user input 644, computer system 600 displays message “Forgot to ask you, can you bring some snacks for the game?” in message region 606, indicating that the message has been transmitted to one or more users in the messaging session. In some embodiments, message region 628a continues to be displayed above message region 606 in messaging user interface 604.

FIGS. 6L-6N illustrate an example of composing an audio message with a delayed transmission time. Starting with FIG. 6L, audio message 654 is shown as a message that has already been drafted while the computer system is operating in a send later mode. For example, at FIG. 6L, computer system 600 displays audio message 654 in send later text field 612b. In some embodiments, text field 612b is displayed in response to a user input corresponding to a send later option (e.g., 610d) in a messaging menu interface (e.g., 610). Send later text field 612b includes delivery time indicator 614b, which indicates the time in which a composed message will be transmitted (e.g., “Tomorrow at 10:00 AM”), send later send icon 622c, and send later cancellation icon 636b.

At FIG. 6M, while continuing to operate in the send later mode, computer system 600 receives (e.g., transmitted from an external device of another user in the messaging session to computer system 600) message 646 “Sure, remind me after my race”. In response to receiving message 646, message region 606 is updated so that message 646 is displayed in message region 606 and the position of message “Forgot to ask you, can you bring some snacks for the game?” is shifted such that it is no longer displayed in messaging interface 604. In some embodiments, while computer system 600 is operating in the send later mode, message region 628a is not updated in response to receiving message 646. At FIG. 6M, computer system detects user input 648 (e.g., a tap input) corresponding to send later send icon 622c.

At FIG. 6N, in response to user input 648, computer system 600 displays message region 628b under message region 628a in messaging user interface 604. Message region 628b includes one or more messages that have been scheduled to be transmitted into the messaging session at a scheduled transmission time (e.g., “Tomorrow at 10:00 AM”) that is later than the scheduled transmission time for the messages in message region 628a (e.g., “Tomorrow at 9:00 AM”). Message region 628b also includes send later header 652, which identifies one or more messages (e.g., including audio message 654) that have a common delayed transmission time (e.g., “Tomorrow 10:00”) in message section 628b. Additionally, in response to user input 648, computer system 600 displays audio message 654 as a composed message in message region 628b. In some embodiments, audio message 654 is displayed with a dashed border and with dimmed playback button 654a, indicating that audio message 654 is a message with a delayed transmission time. At FIG. 6N, computer system 600 detects user input 650 (e.g., a tap input or long press input) corresponding to message “Hey” in message region 628a.

At FIG. 6O, in response to user input 650, computer system 600 displays message editing interface 656, which is overlayed on the display of messaging user interface 604. Message editing interface 656 includes edit option 656a for editing the content of the selected message, copy option 656b for copying the content of the selected message, and delete option 656c for cancelling the scheduled transmission of the selected message. In some embodiments, the display of messaging user interface 604 is dimmed and/or blurred while messaging editing interface 656 is displayed. At FIG. 6O, computer system 600 detects user input 658 (e.g., a tap input) corresponding to delete option 656c.

At FIG. 6P, in response to user input 658, computer system 600 removes the displays of message “Hey” in message region 628a thereby cancelling the scheduled time of message “Hey” at “Tomorrow 9:00 AM”. At FIG. 6P, computer system 600 detects user input 660 (e.g., tap input or long press input) corresponding to send later editing icon 632.

At FIG. 6Q, in response to user input 660, computer system 600 displays send later editing interface 662, which is overlayed on the display of messaging user interface 604. Send later editing interface 662 includes send now option 662a for immediately transmitting the messages in message region 628a and edit time option 662b for modifying the scheduled transmission times of the messages in message region 628a. FIGS. 6Q-6T illustrate examples of two separate user inputs corresponding to send now option 662a and edit time option 662b.

In the first example flowing from FIG. 6Q, computer system detects user input 664a (e.g., a tap input) corresponding to send now option 662a. As shown in FIG. 6R, in response to user input 664a, message region 628a ceases to be displayed in messaging user interface 604 and messages previously displayed in message region 628a (e.g., “Good luck on your race”) are now displayed in message region 606. For example, in FIG. 6R, message “Good luck on your race” is displayed under message 646 in message region 606, indicating that message “Good luck on your race” has been transmitted to one or more users in the messaging session.

In the second example flowing from FIG. 6Q, computer system detects user input 664b (e.g., a tap input) corresponding to edit time option 662b. As shown in FIG. 6S, in response to user input 664b, computer system 600 displays delivery time selection interface 618b. At FIG. 6S, “Tues December 5 10:00 AM” is displayed at the center of the scrollable list (e.g., in response to one or more scroll inputs for selecting the desired time) of delivery time selection interface 618b, which represents the delivery time that is prepared for selection by the user. At FIG. 6S, computer system detects input 620b (e.g. a tap input) corresponding to messaging interface 604.

Continuing the second example flowing from FIG. 6Q, at FIG. 6T, in response to user input 620b, message region 628a ceases to be displayed in messaging user interface 604 and messages previously displayed in message region 628a (e.g., “Good luck on you race”) are now displayed in message region 628b. For example, at FIG. 6T, message “Good luck on your race” is displayed under audio message 654 in message region 628b, indicating that message “Good luck on your race” is scheduled to be transmitted at the same time as audio message 654 (e.g., “Tomorrow 10:00 AM”). At FIG. 6T, computer system detects user input 668 (e.g., a tap input or long press input) corresponding to message 646.

At FIG. 6U, in response to user input 668, computer system 600 displays text field 670 (e.g., with the same visual representation as text field 604b) for drafting a message to be sent as a reply to message 646. In some embodiments, in response to user input 668, computer system 600 ceases operating in a send later mode and text field 670 represents a text field for drafting messages to be sent immediately upon sending. For example, text field 670 includes send icon 640b, which can be selected to immediately transmit a drafted message as a reply to message 646. In some embodiments, in response to user input 668, computer system maintains the display of message 646 and blurs and/or dims the display of all other displayed messages in messaging user interface 604. Additionally, at FIG. 6U, computer system displays message “Don't forget the snacks!” as a drafted message in text field 670 (e.g., in response to detecting one or more inputs interacting with keyboard 604c). At FIG. 6U, computer system 600 detects a series of inputs including user input 672 corresponding to messaging menu icon 604a (e.g., for displaying messaging menu interface 610) and one or more subsequent inputs for initiating the send later mode (e.g., an input corresponding to send later option 610d as shown in FIG. 6B).

At FIG. 6V, after receiving the series of inputs for initiating the send later mode, computer system 600 begins operating in a send later mode and displays message “Don't Forget the snacks!” in send later text field 612c. Send later text field 612c includes delivery time indicator 614c that indicates the scheduled time at which message “Don't forget the snacks!” will be transmitted as a reply to message 646 (e.g., “Tomorrow at 1:00 PM), Send later text field 612c also includes send later send icon 622d. At FIG. 6V, computer system 600 detects user input 674 (e.g., a tap input) corresponding to send later send icon 622d.

At FIG. 6W, in response to receiving user input 674, computer system 600 displays message region 628c under message region 628b in messaging user interface 604. Message region 628c includes one or more messages that have been scheduled to be transmitted into the messaging session at a future scheduled time (e.g., “Tomorrow 1:00 PM”) that is later than the future scheduled time for the messages in message region 628b (e.g., “Tomorrow 10:00 AM”). Message region 628c also includes send later header 678, which identifies one or more messages (e.g., including message “Don't forget the snacks!”) that have a common delayed transmission time (e.g., “Tomorrow 1:00 PM”) in message section 628c. Additionally, in response to user input 674, computer system 600 displays message “Don't forget the snacks!” as a composed message in message region 628c connected to message 646 via reply line 676, indicating that message “Don't forget the snacks!” is scheduled to be transmitted as a reply to message to message 646.

At FIG. 6X, current time indicator 604e has been updated to read “10:04” to reflect that the current time is now 10:04 AM on Tuesday December 5 (e.g., the following day from when the examples of FIGS. 6A-6W take place (e.g., on Monday December 4)). As shown in FIG. 6X, computer system 600 has stopped displaying message region 628b as a result of the current time reaching 10:00 AM on Tuesday December 5. Additionally, at FIG. 6X, audio message 654 and message “Good luck on your race!”, previously displayed in message region 628b, are now displayed under message 646 in message region 606, indicating that audio message 654 and message “Good luck on your race!” were transmitted to one or more users in the messaging session at 10:00 AM on Tuesday December 5.

At FIG. 6Y, current time indicator 604e has been updated to read “1:04” to reflect that the current time is now 1:04 PM on Tuesday December 5 (e.g., the same day as when the example of FIG. 6X takes places). As shown in FIG. 6Y, computer system 600 has stopped displaying message region 628c as a result of the current time reaching 1:00 PM on Tuesday December 5. Additionally, at FIG. 6Y, message “Don't forget the snacks!”, previously displayed in message region 628c, is now displayed under message “Good luck on your race!” in message region 606, indicating that message “Don't forget the snacks!” was transmitted to one or more users in the messaging session at 1:00 PM on Tuesday December 5.

FIG. 6Z illustrates examples of how various types of messages are displayed in messaging user interface 604 as send later draft messages (e.g., displayed in a send later text field (e.g., 612a, 612b, and 612c)), as composed send later messages (e.g., messages displayed in a send later message region (e.g., 628a, 628b, and 628c)), and as transmitted messages (e.g. messages displayed in a transmitted message region (e.g., message region 606)). For example, when audio message 680 is displayed as a send later draft message, playback icon 682a is displayed as an opaque circle (e.g., solid blue) with a white play icon. In some embodiments, when audio message 680 is displayed as a composed send later message, audio message 680 has a dashed border and playback icon 682b is displayed as a dimmed circle (e.g., light blue) with a white play icon. In some embodiments, when audio message 680 is displayed as a transmitted message, audio message 680 has a solid border and playback icon 682c is displayed as an opaque circle with a white play icon (e.g., the same display as the playback icon when audio message 680 is displayed as a send later draft message).

Continuing the example of FIG. 6Z, when linked message 684 is displayed as a send later draft message, the display of linked message title 686a (e.g., Super Jumper Land on Gamer Sphere.com”) and linked message image 688a are both undimmed. In some embodiments, when linked message 684 is displayed as a composed send later message, linked message 684 has a dashed border and linked message title 686b and linked message image 688b are both dimmed. In some embodiments, when linked message 684 is displayed as a transmitted message, linked message 684 has a solid border and linked message tittle 686c and linked message image 688c are both undimmed (e.g., displayed the same as when linked message 684 is displayed as a send later draft message).

Continuing the example of FIG. 6Z, when image message 690 is displayed as a send later draft message, image message 690 is displayed with a solid border and undimmed image content. In some embodiments, when image message 690 is displayed as a composed send later message, image message 690 is displayed with a solid border and dimmed image content. In some embodiments, when image message 690 is displayed as a transmitted message, image message is displayed with a solid border and undimmed image content.

FIG. 7 is a flow diagram illustrating a method for composing messages in a delayed messaging mode, in accordance with some embodiments. Method 700 is performed at a computer system (e.g., 600) (e.g., a smartphone, a smartwatch, a tablet, personal computer and/or a head mounted device). In some embodiments, the computer system (e.g., 600) is in communication with (e.g., includes and/or is connected to) a display generation component (e.g., 602) (e.g., a display, a touch-screen display, a monitor, a holographic display system, and/or a head-mounted display system) and one or more input devices (e.g., 602) (e.g., a touch-sensitive surface (e.g., a touch-sensitive display), a mouse, a keyboard, a remote control, a visual input device (e.g., one or more cameras such as an infrared camera, a depth camera, a visible light camera, and/or a gaze tracking camera), and/or an audio input device (e.g., a microphone)). Some operations in method 700 are, optionally, combined, the orders of some operations are, optionally, changed, and some operation are, optionally, omitted.

As described below, method 700 provides an intuitive way for composing messages in a delayed messaging mode. The method reduces the cognitive burden on a user for composing messages in a delayed message mode thereby creating a more efficient human-machine interface. For battery-operated computing devices, enabling a user to compose messages in a delayed messaging mode faster and more efficiently conserves power and increases the time between battery charges.

While displaying, via the display generation component (e.g., 602), a messaging user interface (e.g., 604) (e.g., an interface for receiving, composing, transmitting, and/or scheduling the delayed transmission of electronic messages (e.g., text messages, audio messages, linked messages, image messages, and/or video messages)) (in some embodiments, the messaging interface includes a first section for displaying received messages, transmitted messages, and/or delayed messages (e.g., messages scheduled to be transmitted at a future time) and a second section that includes a message input field (e.g., 604b 612a, 612b, and/or 612c) (e.g., a message bar) for composing messages)), the computer system (e.g., 600) receives (702), via the one or more input devices (e.g., 602), a first set of one or more inputs (e.g., 604a and/or 610g as shown in FIGS. 6A and 6B).

In response to receiving the first set of one or more inputs (e.g., 604a and/or 610g), the computer system (e.g., 600) activates (704) (e.g., enters and/or transitions to) a delayed messaging mode, wherein the computer system is configured to schedule delayed transmission times of respective messages (e.g., configured to schedule future times for respective messages to be transmitted (e.g., sent to a server and/or an external device (e.g., a device associated with a contact selected by the user of the computer system))) while operating in the delayed messaging mode.

While operating in the delayed messaging mode (706), the computer system composes (708) first message (e.g., drafts a first message in a message input field (e.g., 612a) (e.g., message bar)) (in some embodiments, composing a first message includes receiving an input (e.g., 624) in the message input field (e.g., an input directed to a send icon (e.g., 622a)), and in response to receiving the first input, displaying the first message in the message transcript and ceasing to display the first message in the message input field (e.g., as shown in FIG. 6F)) and composes (710) a second message (e.g., drafts a second message in a message input field; in some embodiments, composing the second message occurs after receiving an input to display the first message in the message transcript and ceasing to display the first message in the message field (e.g., as shown in FIG. 6G)), wherein the first message and the second message are scheduled to be transmitted at a first predetermined time (e.g., a future scheduled time). In some embodiments, the computer system automatically remains in the delayed messaging mode after composing the first message. In some embodiment, the computer system automatically remains in the delayed messaging mode after composing the second message until the computer system receives an input to exit the delayed messaging mode (e.g., selection of a cancel affordance, exiting the messaging user interface). In some embodiments, the first and second messages are automatically transmitted once the first predetermined time is reached. In some embodiments, transmitting (e.g., sending to an external device) the first and second message after the first predetermined time is reached does not send an indication to the receiving device that the first and second message were composed in a delayed sending mode (e.g., messages composed in a delayed messaging mode and messages composed while not in a delayed messaging mode will have the same visual representation on the receiving device). Composing a first message and second message, while operating in a delayed messaging mode, that are scheduled to be transmitted at a first predetermined time, allows the user to compose multiple messages to be transmitted at a future time without having to individually program a delayed delivery time for individual messages, thereby reducing the number of inputs needed to perform an operation.

In some embodiments, a first menu (e.g., 610 as shown in FIG. 6B) of a plurality of message composition options (e.g., 610a, 610b, 610c, 610d, 610e, and/or 610f) is displayed in the messaging user interface (e.g., a menu containing options for composing messages with images, videos, audio, web links, map links (e.g., links to a current location of the user of the computer system), music links (e.g., links to a music streaming service). In some embodiments, the menu is displayed, via the display generation component, in response to receiving a prior input (e.g., 608) corresponding to a menu icon (e.g., 604a) that is displayed in the messaging user interface (e.g., 604) (e.g., adjacent to the message input field (e.g., 604b) (e.g., message bar)) (e.g., as shown in FIG. 6A)), wherein the plurality of message composition options includes a delayed messaging mode option (e.g., 610d), and the first set of one or more inputs includes a first input (e.g., 610g) corresponding to (e.g., directed toward) the delayed messaging mode option (e.g., 610d) (e.g., an icon and/or affordance for a delayed messing mode), wherein the delayed messaging mode is activated in response to receiving a first input (e.g., 610g). Displaying, in the messaging user interface, a first menu of a plurality of message composition options that include a delayed messaging mode option that is selectable to activate the delayed messaging mode provides an efficient selection method for activating the delayed messaging mode without having to exit the messaging user interface, thereby reducing the number of inputs required by the user to perform an operation.

In some embodiments, while operating in the delayed messaging mode, the computer system (e.g., 600) displays, in the messaging user interface (e.g., 604) and via the display generation component (e.g., 602), a delivery time indicator (e.g., 614a, 614b, and/or 614c) (in some embodiments, the delivery time indicator is displayed in the message input field (e.g., 612a, 612b, and/or 612c) (e.g., message bar)) that identifies the first predetermined time, and wherein the delivery time indicator, when selected, initiates a process for changing the first predetermined time to a second predetermined time (e.g., as shown in FIG. 6D). In some embodiments, selection of the delivery time indicator causes the display of a delivery time selection interface (e.g., 618a) (e.g., a scrollable list of selection times), wherein a second predetermined time, different from the first predetermined time, can be selected, and wherein in response to selecting the second predetermined time, the delivery time indicator identifies the second predetermined time and ceases identifying the first predetermined time (e.g., as shown in FIG. 6E). Displaying a delivery time indicator in the messaging user interface that identifies the first predetermined time allows the user to know the scheduled delivery time before or during the composition of a message in the delayed messaging mode, thereby providing improved visual feedback to the user. Further, displaying a delivery time indicator that is selectable to change the first predetermined time to a second predetermined time provides the user with an efficient method for modifying the scheduled delivery time of a delayed message without having to program a specific delivery before entering the delayed messaging mode, thereby reducing the number of inputs required to perform an operation.

In some embodiments, the first predetermined time (e.g., “Tomorrow at 8:00 AM as shown in FIG. 6C) is a default time. In some embodiments, the first predetermined time is selected by the computer system as the default time based on the frequency of messages composed in the delayed messaging mode at the first predetermined time. In some embodiments, the first predetermined time is always the default time. Displaying a delivery time indicator with a default time allows the user to compose a delayed message without requiring any inputs to schedule a particular time when the default time is the desired delivery time, thereby reducing the number of inputs required to perform an operation.

In some embodiments, while operating in the delayed messaging mode, the computer system (e.g., 600) displays, in the messaging user interface (e.g., 604) and via the display generation component (e.g., 602), a selectable cancellation interface object (e.g., 636a and/or 636b) (in some embodiments, the selectable cancellation interface object is a button displayed in the delivery time indicator (e.g., 614a, 614b, and/or 614c)) that, when selected, causes deactivation of the delayed messaging mode (e.g., as shown in FIGS. 6G and 6H). In some embodiments, the computer system is configured to transmit the respective messages without delaying respective transmission times of the respective messages (e.g., configured to transmit (e.g., send to a server and/or an external device) a composed message immediately upon receiving an input to send the composed message (e.g., an input directed to a send button (e.g., 640a and/or 640b) in the message input field (e.g., 640b) (e.g., message bar)) while the delayed messaging mode is deactivated). Displaying a selectable cancellation interface object that can be selected to deactivate the delayed messaging mode provides an efficient selection method for deactivating the delayed messaging mode without having to exit the messaging user interface, thereby reducing the number of inputs required to perform an operation.

In some embodiments, after composing the first message and the second message in the delayed messaging mode, the computer system (e.g., 600) receives a second input (e.g., 634) corresponding to (e.g., directed towards) the selectable cancellation interface object (e.g., 636a). In response to receiving the second input, the computer system (e.g., 600) deactivates the delayed messaging mode (e.g., as shown in FIGS. 6G and 6H). While the delayed messaging mode is deactivated and while continuing to display the messaging user interface, the computer system (e.g., 600) composes a third message without delaying a transmission time of the third message (e.g., as shown in FIGS. 6I-6K). In some embodiments, in response to deactivating the delayed messaging mode, the delivery time indicator (e.g., 612a) ceases to be displayed in the messaging user interface. In some embodiments, after composing the first message and the second message (e.g., displaying the first and second message in a message transcript) and after deactivating the delayed messaging mode, the first and second message continue to be displayed in the message transcript (e.g., as shown in FIG. 6H). Composing a third message without delaying a transmission time of the third message after deactivating the delayed messaging mode via the selectable cancellation interface object allows the user to compose delayed messages and messages without a delayed message time without exiting the messaging user interface, thereby reducing the number on inputs required to perform an operation.

In some embodiments, the messaging user interface includes a first message input field (e.g., 612a, 612b, and/or 612c) (e.g., a message bar in a delayed messaging mode), the first message is a first type of message (e.g., a non-text message (e.g., an image and/or video message (e.g., 690), a message that includes a link to a respective source (e.g., 684), and/or an audio message (e.g., 654 and/or 680)) as shown in FIGS. 6L, 6M, and 6Z), and composing the first message includes displaying, in the first message input field (e.g., 612a) and via the display generation component (e.g., 602), a first preview of the first message (e.g., a draft of the first message before receiving an input (e.g., 622a, 622b, and/or 622c) to schedule the delayed transmission of the first message) (in some embodiments, the preview is a visual representation of the first message in the message bar that depicts how the first message will later be displayed in the message transcript once the delayed transmission of the message is scheduled; in some embodiments, the preview is a visual representation of the first message in the message bar that depicts how the first message will later be displayed once the delivery time of the first message is reached (e.g., a delayed message that has transitioned to a sent message) (e.g., as shown in FIG. 6Z)) with a first visual representation (e.g., the message preview is dimmed and/or has a dashed border). In some embodiments, while the computer system (e.g., 600) is not operating in the delayed messaging mode, the computer system (e.g., 600) composes a fourth message of the first type of message, wherein composing the fourth message includes displaying, in the first message input field (e.g., 604b) and via the display generation component, a second preview of the fourth message with a second visual representation (e.g., the message preview is not dimmed and has a solid border) that is different from the first visual representation. In some embodiments, the first visual representation is the same as the second visual representation. In some embodiments, certain types of messages can only be composed while the computer system is not operating in a delayed messaging mode (e.g., payment messages and/or messages that share a live location associated with the user). Composing a fourth message of the first type, while the computer system is not operating in the delayed messaging mode, and displaying a second preview of the fourth message with a second visual representation that is different from the first visual representation provides the user with visual cues for when the third message is being composed with or without a delayed delivery time, thereby providing improved visual feedback to the user.

In some embodiments, the first type of message is a message that includes a respective image (e.g., 690 as shown in FIG. 6Z) (e.g., a still photo and/or a thumbnail for a video). In some embodiments, the first visual representation of the first preview of the message that includes the respective image includes a dimmed preview of the image, and the second visual representation of the second preview of the message that includes a respective image includes an undimmed preview of the image with a solid border. Composing a fourth message of the first type, while the computer system is not operating in the delayed messaging mode, and displaying a second preview of the fourth message with a second visual representation that is different from the first visual representation, wherein the first type of message is a message that includes a respective image, provides the user with visual cues for when the message that includes a respective image is being composed with or without a delayed delivery time, thereby providing improved visual feedback to the user.

In some embodiments, the first type of message is a message that includes a link (e.g., 684 as shown in FIG. 6Z) (e.g., a hyperlink and/or an embedded link that is selectable once the message has been displayed in the message transcript (e.g., after being transmitted and/or scheduled to be transmitted at a future time)) to a respective source (e.g., an application (e.g., a maps application, a media player) and/or a link to website (e.g., an online article website, an online video streaming website)). In some embodiments, the first visual representation of the first preview of the message that includes the link to the respective source includes a dimmed image of the message link with a dashed border, and the second visual representation of the second preview of the message that includes a link to the respective source includes an undimmed image of the message link with a solid border. Composing a fourth message of the first type, while the computer system is not operating in the delayed messaging mode, and displaying a second preview of the fourth message with a second visual representation that is different from the first visual representation, wherein the first type of message is a message that includes a link to a respective source, provides the user with visual cues for when the message that includes a link is being composed with or without a delayed delivery time, thereby providing improved visual feedback to the user.

In some embodiments, the first type of message is an audio message (e.g., 654 and/or 680 as shown in FIGS. 6L, 6M, and 6Z) (e.g., a message record using a microphone of the computer system). In some embodiments, the first visual representation of the first preview of the audio message includes an image of the audio message with a dashed border, and the second visual representation of the second preview of the audio message includes an image of the audio message with a solid border. Composing a fourth message of the first type, while the computer system is not operating in the delayed messaging mode, and displaying a second preview of the fourth message with a second visual representation that is different from the first visual representation, wherein the first type of message is an audio message, provides the user with visual cues for when the audio message is being composed with or without a delayed delivery time, thereby providing improved visual feedback to the user.

In some embodiments, while operating in the delayed messaging mode, the computer system (e.g., 600) displays, in the messaging user interface (e.g., 604) and via the display generation component (e.g., 602), a first selectable message composition object (e.g., 622a, 622b, 622c, and/or 622d) (e.g., a send message icon in the in the message input field). In some embodiments, the messaging user interface includes a first message transcript (e.g., a message log including sent messages and/or scheduled messages from the user of the computer system and/or received messages from a user of an external device). In some embodiments, composing the first message includes receiving, via the one or more input devices (e.g., 602), a fourth input (e.g., 624) corresponding to the first selectable message composition object (e.g., 622a), and in response to receiving the fourth input (e.g., 624), displaying, via the display generation component (e.g., 602), the first message in the first message transcript (e.g., as shown in FIG. 6G). In some embodiments, composing the first message includes displaying the first message as a preview in a message input field (e.g., 612a) and, in response to receiving the fourth input, the first message ceases to be displayed in the message input field. In some embodiments, composing the second message includes receiving, via the one or more input devices, a fifth input (e.g., 626) corresponding to the first selectable message composition object (e.g., 622b), and in response to receiving the fifth input (e.g., 626), displaying, via the display generation component (e.g., 602), the second message in the first message transcript (e.g., as shown in FIG. 6G). In some embodiments, composing the second message includes displaying the second message as a preview in a message input field (e.g., 612a) and, in response to receiving the fifth input, the second message ceases to be displayed in the message input field. Displaying a first selectable message composition object in the messaging user interface that is selectable to display the first message and the second message in the message transcript provides an efficient selection message for completing the composition of multiple delayed messages and displaying them in the first message transcript without having to exit the delayed messaging mode or the messaging user interface, thereby reducing the number of inputs required to perform an operation.

In some embodiments, the first message transcript includes a first message section (e.g., 606) that includes one or more transmitted messages (e.g., text messages that have already been transmitted (e.g., sent to a server and/or an external device (e.g., a device associated with a contact selected by the user of the computer system))) and the first message and the second message are displayed in a first subsection (e.g., 628a as shown in FIG. 6G) (e.g., a section for messages that are scheduled to be delivered at a first predetermined time) of a second message section of the first message transcript (e.g., a section for scheduled delayed messages) that is visually separated from the first message section (e.g., 606) of the first message transcript. In some embodiments, the first section of the message transcript includes received messages. Displaying the first message and the second message in a first subsection of the second message section that is different from the first message section provides the user with a visual indication that the first and second messages are delayed messages that are distinct from transmitted messages in the first section, thereby providing improved visual feedback to the user.

In some embodiments, while the computer system (e.g., 600) is operating in the delayed messaging mode, the computer system (e.g., 600) composes a fifth message (e.g., 654), wherein the fifth message is scheduled to be transmitted at a second predetermined time different from the first predetermined time. In some embodiments, in response to composing the fifth message, the computer system (e.g., 600) displays, via the display generation component, the fifth message (e.g., 654) in a second subsection (e.g., 628b) (e.g., a section for messages that are scheduled to be delivered at a second predetermined time different from the first predetermined time) of the second message section that is visually separated from the first subsection (e.g., 628a) of the second message section (e.g., as shown in FIG. 6N). Displaying the fifth message in the second subsection of the second message section that is visually separated from the first subsection of the second message section provides the user with a visual indication that the fifth message is a delayed message that is scheduled to be transmitted at a different time than the first message and the second message, thereby providing improved visual feedback to the user.

In some embodiments, the first message includes first content that is received (e.g., prepared and/or drafted in a message input field (e.g., 604b) (e.g., message bar)) while the computer system is not operating in the delayed messaging mode (e.g. the content is received before the delayed messaging mode is activated). Composing the first message that includes first content that is prepared while the computer system is not operating in the delayed messaging mode allows the user to begin composition of a delayed message before needing to activate the delayed messaging mode, thereby reducing the number of inputs required to perform an operation.

In some embodiments, the second message includes second content that is received (e.g., drafted in a message input field (e.g., 612a) (e.g., message bar)) while the computer system (e.g., 600) is operating in delayed messaging mode. In some embodiments, the first message can also include first content that is prepared after the delayed messaging mod is activated. Composing the second message that includes second content that is prepared while the computer system is operating in the delayed messaging mode allows the user to begin composition of delayed message without needing to exit the delayed messaging mode between individually composed delayed messages, thereby reducing the number of inputs required to perform an operation.

In some embodiments, the messaging user interface includes a second message input field (604b, 612a, 612b, and/or 612c) (e.g., message bar). In accordance with a determination that the computer system (e.g., 600) is operating in the delayed messaging mode, the second message input field (e.g., 612a, 612b, and/or 612c) is displayed in a first visual style (e.g., a message bar has dashed border and/or includes a delivery time indicator). In accordance with a determination that the computer system (e.g., 600) is not operating in the delayed messaging mode, the second message input field (e.g., 604b) is displayed in a second visual style (e.g., the message bar has solid border and does not have a delivery time indicator) that is different from the first visual style. Displaying the second message input field in a first visual style when the computer system is operating in a delayed messaging mode and displaying the second message input field in a second visual style when the computer system is not operating a delayed messaging mode provides the user with visual cues for when a composed message will be sent as a delayed message, thereby providing improved visual feedback to the user.

In some embodiments, the second message input field includes a second selectable message composition object (e.g., 622a, 622b, 622c, 622d, 640a, and/or 640b) (e.g., a send icon) that is selectable to compose a respective message (e.g., scheduling a delayed messaging time for the respective message or immediately transmitting the respective message depending on whether the computer system is operating (or not operating) in the delayed messaging mode). In accordance with a determination that the computer system (e.g., 600) is operating in the delayed messaging mode, the second selectable message composition object (e.g., 622a, 622b, 622c, and/or 622d) is presented in a third visual style (e.g., the send icon is a translucent circle (e.g., light blue) with an opaque arrow icon (e.g., a dark blue arrow icon)). In accordance with a determination that the computer system is not operating in the delayed messaging mode, the second selectable message composition object (e.g., 640a and/or 640b) is presented in a fourth visual style (e.g., the send icon is an opaque circle (e.g., dark blue) with an arrow icon of a lighter shade (e.g., a white arrow)) that is different than the third visual style. Displaying the second selectable message composition object in a third visual style when the computer system is operating in a delayed messaging mode and displaying the second selectable message composition object in a fourth visual style when the computer system is not operating a delayed messaging mode provides the user with visual cues for when a composed message will be sent as a delayed message, thereby providing improved visual feedback to the user.

In some embodiments, the messaging user interface (e.g., 604) includes a second message transcript (e.g., 606) with a first received message (e.g., 646) (e.g., a message (e.g., text, photo, audio, and/or link message that was sent from an external device to the computer system)). In some embodiments, the first message includes third content that is received via the one or more input devices (in some embodiments, the third content is received while the computer system is not operating in the delayed messaging mode; in some embodiments, the third content is received while the computer system is operating in the delayed messaging mode), wherein receiving the third content includes receiving a sixth input (e.g., 668 as shown in FIG. 6T) (e.g., a tap or a long press input) corresponding to the first received message (e.g., 646). In some embodiments, in response to receiving the sixth input (e.g., 668), the computer system (e.g., 600) displays, via the display generation component, a third message input field (e.g., 670 as shown in FIG. 6U) (in some embodiments, the second message input field is displayed adjacent to received message, to which the third input is directed, indicating that a composed message in the second message input field will be composed in response to the received message), and receiving a seventh input (e.g., one or more inputs on a keyboard user interface (e.g., 604c)) to prepare (e.g., draft before selection of a respective send icon that is displayed in the second message input field) the third content in the third message input field (e.g., 670). Composing the first message that includes third content that is prepared in a second message input field that is displayed in response to a sixth input corresponding to a received message allows the user to compose a reply message with a delayed delivery time without having to exit the messaging user interface, thereby reducing the number of inputs required to perform an operation.

Note that details of the processes described above with respect to method 700 (e.g., FIG. 7) are also applicable in an analogous manner to the methods described below. For example, methods 800 and 1000 optionally include one or more of the characteristics of the various methods described above with reference to method 700. For example, the computer system of method 700 can compose messages in a displayed messaging and display them in a message transcript via method 800. As another example, the computer system of method 1000 can be utilized to customize the visual representation of a linked message that is composed in a delayed messaging mode via method 700. For brevity, these details are not repeated below.

FIG. 8 is a flow diagram illustrating a method for displaying delayed messages in a message transcript, in accordance with some embodiments. Method 800 is performed at a computer system (e.g., 600) (e.g., a smartphone, a smartwatch, a tablet, personal computer and/or a head mounted device). In some embodiments, the computer system (e.g., 600) is in communication with (e.g., includes and/or is connected to) a display generation component (e.g., 602) (e.g., a display, a touch-screen display, a monitor, a holographic display system, and/or a head-mounted display system) and one or more input devices (e.g., 602) (e.g., a touch-sensitive surface (e.g., a touch-sensitive display), a mouse, a keyboard, a remote control, a visual input device (e.g., one or more cameras such as an infrared camera, a depth camera, a visible light camera, and/or a gaze tracking camera), and/or an audio input device (e.g., a microphone)). Some operations in method 800 are, optionally, combined, the orders of some operations are, optionally, changed, and some operation are, optionally, omitted.

As described below, method 800 provides an intuitive way for displaying delayed messages in a message transcript in accordance with some embodiments. The method reduces the cognitive burden on a user for displaying delayed messages in a message transcript thereby creating a more efficient human-machine interface. For battery-operated computing devices, enabling a user to displaying delayed messages in a message transcript faster and more efficiently conserves power and increases the time between battery charges.

The computer system (e.g., 600) displays (802), via the display generation component (e.g., 602) a message transcript (e.g., a section of the messaging user interface that displays received messages, transmitted messages, and/or delayed messages (e.g., messages scheduled to be transmitted at a future time)) in a messaging user interface (e.g., 604) (e.g., an interface for receiving, composing, transmitting, and/or scheduling the delayed transmission of electronic messages (e.g., text messages, audio messages, linked messages, image messages, and/or video messages)).

Displaying the message transcript includes concurrently displaying a first message section (804) (e.g., 606) including one or more transmitted messages (e.g., text messages that have already been transmitted (e.g., sent to a server and/or an external device (e.g., a device associated with a contact selected by the user of the computer system))), wherein the one or more transmitted messages have a first visual representation (e.g., a first arrangement of colors (e.g., blue background with white text) and/or a first visual border style (e.g., solid border)) and a second message section (806) (e.g., 628a, 628b, and/or 628c) including one or more delayed messages that are scheduled to be transmitted at a first predetermined time (e.g., messages scheduled to be transmitted at a future time), wherein the one or more delayed messages have a second visual representation (e.g., a second arrangement of colors (e.g., white background with blue text) and/or a second visual border style (e.g., dashed and/or dotted line border)) that is different from the first visual representation.

The computer system (e.g., 600) receives (808), via the one or more input devices (e.g., 602), a first set of one or more inputs to compose and transmit (e.g., transmit immediately or transmit at a later/delayed time) a first message (e.g., to send a drafted messaged (e.g., a message drafted in a message input field (e.g., a message bar))).

In response to receiving the first set of one or more inputs (810) (e.g., 644 as shown in FIG. 6J) and in accordance with a determination that the computer system is not operating in a delayed messaging mode (e.g., a mode where the computer system is configured transmit (e.g., sent to a server and/or an external device (e.g., a device associated with a contact selected by the user of the computer system)) a composed message upon receiving the first set of one or more input without delaying the transmission of the message), the computer system (e.g., 600) displays (812) (in some embodiments, and transmitting) the first message in the first message section (e.g., 606) with the first visual representation (e.g., as shown in FIG. 6K).

In response to receiving the first set of one or more inputs (810) (e.g., 624 and/or 626) and in accordance with a determination that the computer system is operating in a delayed messaging mode (e.g., a mode where the computer system is configured to schedule future times for respective messages to be transmitted), the computer system (e.g., 600) displays (814) (in some embodiments, and scheduling for later transmission) the first message in the second message section (e.g., 628a) with the second visual representation (e.g., as shown in FIGS. 6F and 6G). In some embodiments, the first message section is visually separated from the first message section (e.g., the sections do not overlap) in the messaging user interface. Concurrently displaying, in a message transcript of a messaging user interface, a first message section including one or more transmitted messages with a first visual representation and a second message section including one or more delayed messages with a second visual representation provides a visual indication to the user which messages in a message transcript have already been transmitted and which messages are scheduled to be transmitted at a later time, thereby improving the visual feedback for the user. In response to receiving a first set of one or more inputs to compose and transmit a first message, displaying the first message in the first message section with the first visual representation or the second message section with the second visual representation, depending on whether the computer system is operating in the delayed messaging mode, allows the user to efficiently compose different types messages (e.g., immediately transmitted or messages with a delayed transmission time) from the same messaging user interface. This method of composing different message type reduces the number of inputs to perform an operation, thereby increasing the operating efficiency of the computer system. Further, the placement of the composed first message in the first message section or the second message section provides visual confirmation to the user that the first message was composed in the desired message operating mode, thereby providing improved visual feedback to the user.

In some embodiments, the second message section (e.g., 628a) is displayed adjacent to (e.g., below the first message section if the message transcript is displayed vertically or to the right of the first message section if the message transcript is displayed horizontally) the first message section (e.g., 606) in the message transcript. In some embodiments, the second message section has a heading indicating that the second messages section is a section containing messages scheduled to be sent at a later time. Displaying the second message section adjacent to the first message section provides an intuitive way for the user to visually distinguish messages that have already been transmitted with messages that are scheduled to be transmitted later, thereby providing improved visual feedback to the user.

In some embodiments, the first message section (e.g., 606) includes one or more received messages (e.g., messages sent from an external device and received by the computer system). In some embodiments, the second message section does not include any received messages. Displaying received messages in the first message section along with the one or more transmitted messages further provides a visual distinction between the first message section and the second message section. This provides an intuitive way for the user to visually distinguish messages that have already been transmitted and/or received with messages that are scheduled to be transmitted later, thereby providing improved visual feedback to the user.

In some embodiments, receiving the first set of one or more inputs to compose and transmit the first message includes scheduling the first message to be transmitted at the first predetermined time (e.g., a future scheduled time). In some embodiments, the first message is displayed in a first subsection (e.g., 628a) (e.g., a section for messages that are scheduled to be delivered at a first predetermined time) of the second message section. In some embodiments, while the computer system (e.g., 600) is operating in the delayed messaging mode, the computer system (e.g., 600) receives, via the one or more input devices (e.g., 602), a second set of one or more inputs (e.g., 648 as shown in FIG. 6M) to compose and transmit a second message (e.g., the one or more inputs includes drafting a message in a message input field and receiving an input directed to a send icon n the message input field), wherein receiving the second set of one or more inputs includes scheduling the second message to be transmitted at a second predetermined time (e.g., a time earlier or later than the first predetermined time) that is different from the first predetermined time. In some embodiments, in response to receiving the second set of one or more inputs (e.g., 648), the computer system displays the second message in a second subsection (e.g., 628b as shown in FIG. 6N) (e.g., a section for messages that are scheduled to be delivered at a second predetermined time different from the first predetermined time) of the second message section that is different from the first subsection (e.g., 628a) of the second message section. Displaying the first message in the first subsection of the second message section and displaying the second message in the second subsection of the second message section allows the user to visually distinguish between delayed messages that are scheduled for different times, thereby improving the visual feedback to the user.

In some embodiments, in accordance with a determination that the second predetermined time is before (e.g., first in time) the first predetermined time, the second subsection is displayed between the first subsection of the second message section and the first message section (in some embodiments, the message transcript is displayed vertically and the second subsection of the second message section is displayed below the first message section and above the first subsection of the second message section; in some embodiments, the message transcript is displayed horizontally and the second subsection of the second message section is displayed to the right of the first message section and to the left of the first subsection of the second message section). In some embodiments, in accordance with a determination that the second predetermined time is after (e.g., later in time) the first predetermined time, the second subsection is not displayed between the first subsection of the second messages section and the first message section (e.g., as shown in FIG. 6N). In some embodiments, the message transcript is displayed vertically and the second subsection of the second message section is displayed below both the first message section and the first subsection of the second message section. In some embodiments, the message transcript is displayed horizontally and the second subsection of the second message section is displayed to the right of both the first message section and the first subsection of the second message section. Displaying the second subsection between or not between the first subsection of the second message section based on the whether the second predetermined time is before or after the first predetermined time provides a chronological arrangement of delayed messages that are scheduled at different times, such that the user can quickly and efficiently search for messages that are scheduled to be transmitted the soonest (or latest), thereby improving the visual feedback to the user.

In some embodiments, the second message section includes a first indicator (e.g., 630 as shown in FIG. 6F) (e.g., a heading for one or more delayed messages that identifies the scheduled delivery time of all the delayed messages under that heading) that identifies the first predetermined time at which the one or more delayed messages are scheduled to be transmitted, and a first selectable scheduling modifier (e.g., 632) (in some embodiments, the first selectable scheduling modifier is the first indicator; in some embodiments, the first selectable scheduling modifier is a selectable object separate from the first indicator). In some embodiments, the computer system (e.g., 600) receives, via the one or more input devices (e.g., 602), a first input (e.g., 660 as shown in FIG. 6P) (e.g., a tap input or long press input) corresponding to the first selectable scheduling modifier (e.g., 632). In some embodiments, in response to receiving the first input (e.g., 660), the computer system (e.g., 600) displays a first menu (e.g., 662) (e.g., a pop-up menu of selectable options overlayed on the messaging user interface) that includes a first plurality of options (e.g., 662a and 662b) corresponding to the one or more delayed messages. Displaying a first menu with a first plurality of options in response to receiving the input corresponding to the first selectable scheduling modifier provides an efficient method of displaying options for a set of delayed messages using a single input and without exiting the messaging user interface, thereby reducing the number on inputs required to perform an operation.

In some embodiments, the computer system (e.g., 600) receives, via the one or more input devices (e.g., 602), a second input (e.g., 664a or 664b). In some embodiments, in accordance with a determination that the second input (e.g., 664a) corresponds to a first option (e.g., 662a) (e.g., an option to immediately transmit the one or more delayed message that were previously scheduled to be transmitted at a future time) of the first plurality of options corresponding to the one or more delayed messages, the computer system (e.g., 600) transmits (e.g., sending to an server and/or an external device; immediately sending without delaying the transmission) the one or more delayed messages (e.g., as shown in FIG. 6R). In some embodiments, in accordance with a determination that the second input (e.g., 664b) corresponds to a second option (e.g., 662b) of the first plurality of options corresponding to the one or more delayed messages, the computer system (e.g., 600) displays a first editing interface (e.g., 618b as shown in FIG. 6S) for modifying the first predetermined time at which the one or more delayed messages are scheduled to be transmitted. Receiving a second input and transmitting the one or more delayed messages or displaying a first editing interface for modifying the first predetermined time, depending on whether the second input corresponds to the first option or the second option, provides an efficient method of modifying the scheduled delivery time (e.g., changing the delivery time to now or a different future time) of a previously composed delayed message without having to delete and redraft the existing message. This method also allows the user to modifying the scheduled delivery time of the previously composed delayed message without exiting the messaging user interface, thereby reducing the number of inputs required to perform an operation.

In some embodiments, transmitting the one or more delayed messages includes ceasing to display the one or more delayed messages in the second message section (in some embodiments, ceasing to display the one or more delayed messages in the second message section also ceases to display the first indicator (e.g., the heading identifying a first delivery time of the one or more delayed messages)) and displaying the one or more delayed messages in the first message section (e.g., as shown in FIG. 6R). In some embodiments, displaying the one or more delayed messages in the first message section includes displaying the one or more delayed messages with a first visual representation (e.g., the same visual representation as other previously transmitted messages). Ceasing to display the one or more delayed messages in the second message section and displaying the one or more delayed messages in the first message section provides visual confirmation to the user that the previously composed delayed messages have been transmitted and are no longer scheduled to be transmitted at a future time, thereby improving the visual feedback to the user.

In some embodiments, modifying the first predetermined time at which the one or more delayed messages are scheduled to be transmitted maintains the display of the one or more delayed messages in the second message section (e.g., as shown in FIG. 6T). In some embodiments, modifying the first predetermined time causes the one or more delayed messages to be displayed under a second indicator (e.g., a second heading identifying a second future delivery time different from the first future delivery time). In some embodiments, maintaining the display of the one or more delayed messages in the second message section does not change the visual representation of the one or more delayed messages (e.g., they are still displayed with a second visual representation). Modifying the first predetermined time that the one or more delayed messages are scheduled to be transmitted and maintaining the display of the one or more delayed messages in the second messages section provides visual confirmation to the user that the one or more delayed messages are still messages scheduled to be transmitted at a future time but have a different scheduled delivery time, thereby improving visual feedback for the user.

In some embodiments, the one or more delayed messages cease to be displayed in the second message section and are displayed in the first message section when the first predetermined time is reached (e.g., as shown in FIGS. 6W and 6X) (e.g., the current time matched the scheduled delivery time). In some embodiments, displaying the one or more delayed messages in the first message section includes displaying the one or more delayed messages with a first visual representation (e.g., the same visual representation as other previously transmitted messages). Ceasing displaying the one or more delayed messages in the second message section and displaying them in the first message section when the first predetermined time is reached provides visual confirmation to the user that the delivery time of the previously scheduled delayed messages has been reached and that those messages have now been transmitted, thereby providing improved visual feedback to the user.

In some embodiments, the one or more delayed messages have the first visual representation when the one or more delayed messages are displayed in the first message section (e.g., as shown in FIGS. 6R, 6W, and 6X). Ceasing displaying the one or more delayed messages in the second message section, with the second visual representation, and displaying them in the first message section with, with the first visual representation, when the first predetermined time is reached provides visual confirmation to the user that the delivery time of the previously scheduled delayed messages has been reached and that those messages have now been transmitted, thereby providing improved visual feedback to the user.

In some embodiments, the one or more delayed messages include a first delayed message that is not a text message (e.g., 654, 680, 684, and/or 690) (e.g., the message. includes images, audio, and/or a link to a respective source). In some embodiments, in accordance with a determination that the first delayed message is a delayed message of a first type (e.g., 690) (e.g., image message), the second visual representation (e.g., a representation of messages that have a later delivery time that is different from the first visual representation of already delivered messages) (in some embodiments, delayed text messages have a dashed border and transparent background, delayed photo and/or video messages have a dimmed background, delayed linked messages have a dimmed background and dashed border, and audio messages have a dashed border) of the first delayed message is displayed in a first visual style (e.g., dimmed) (e.g., as shown in FIG. 6Z). In some embodiments, in accordance with a determination that the first delayed message is a delayed message of second type (e.g., 684) (e.g., a message with a link to a respective source), the second visual representation of the first delayed message is displayed in a second visual style (e.g., dimmed and dashed) that is different from the first visual style (e.g., as shown in FIG. 6Z). Displaying the first delayed message that is not a text message with a first visual style or a second visual style depending on whether the first delayed message is of a first or second type provides the user with distinct visual representations of different non-text messages that are scheduled to be delivered at a future time. Having distinct visual representations for delayed messages that are non-text messages provides specific visual confirmation about the delivery status for different types of non-text messages, thereby providing improved visual feedback to the user.

In some embodiments, the delayed message of a first type is a delayed message that includes a respective image (e.g., 690) (e.g., a still photo and/or a thumbnail for a video). Having distinct visual representations for delayed messages that include a respective image provides specific visual confirmation about the delivery status for messages that include a respective image, thereby providing improved visual feedback to the user.

In some embodiments, the delayed message of a first type is a delayed message that includes a link (e.g., a hyperlink and/or an embedded link that is selectable once the message has been displayed in the message transcript (e.g., after being transmitted and/or scheduled to be transmitted at a future time)) to a respective source (e.g., 684) (e.g., an application (e.g., a maps application, a media player) and/or a link to website (e.g., an online article website, an online video streaming website)). Having distinct visual representations for delayed messages that include a link to a respective source provides specific visual confirmation about the delivery status for messages that include a link to a respective source, thereby providing improved visual feedback to the user.

In some embodiments, the delayed message of the first type is a delayed audio message (e.g., 680) (e.g., a message record using a microphone of the computer system). In some embodiments, the first visual representation of the first preview of the audio message includes an image of the audio message with a dashed border. Having distinct visual representations for delayed audio messages provides specific visual confirmation about the delivery status for audio messages, thereby providing improved visual feedback to the user.

In some embodiments, the first delayed message has the first visual representation when the first predetermined time is reached (e.g., as shown in FIG. 6Z). In some embodiments, the first visual representation of a message type that includes a link to the respective source includes an undimmed image of the message link with a solid border. In some embodiments, the first visual representation of a message type that includes a respective image includes an undimmed preview of the image with a solid border. In some embodiments, the first visual representation of a message type that is an audio message includes an image of the audio message with a solid border. Displaying the first delayed message with the first visual representation when the first predetermined time is reached provides visual confirmation to the user that the delivery time of the previously scheduled non-text message has been reached and that the non-text message has now been transmitted, thereby providing improved visual feedback to the user.

In some embodiments, the computer system (e.g., 600) receives, via the one or more input devices (e.g., 602), a third input (e.g., 650 as shown in FIG. 6N) corresponding to a respective (e.g., an individual message in a section of multiple delayed messages scheduled for the same or different delivery times) delayed message of the one or more delayed messages. In some embodiments, in response to receiving the third input (e.g., 650), the computer system (e.g., 600) displays a second menu (e.g., 656 as shown in FIG. 6O) that includes a second plurality of options (e.g., 656a and 656b) corresponding to the respective delayed message (e.g., options specifically corresponding to an individual message in the section of multiple delayed messages). Displaying a second menu with a second plurality of options corresponding to the respective delayed message in response to receiving the input corresponding to the respective delayed message provides an efficient method of displaying options for a specific previously composed delayed message without needing to exit the messaging user interface, thereby reducing the number on inputs required to perform an operation.

In some embodiments, while the computer system is not operating in the delayed messaging mode, the computer system (e.g., 600) starts to compose (e.g., beginning to draft a message in a message input field (e.g., message bar) while in the delayed messaging mode) a third message (e.g., “Forgot to ask you . . . ” as shown in FIG. 6I). In some embodiments, in response to starting to compose the third message, the computer system (e.g., 600) ceases to display the second message section (e.g., 628a) in the message transcript (e.g., as shown in FIG. 6I). In some embodiments, ceasing displaying the second message section includes animating the transition of the second message section underneath the message input field until the second message section is completely obscured from view. Ceasing displaying the second message section in response to starting to compose the third message section while the computer is not operating in a delayed messaging mode provides a visual indication to the user that the third message will be displayed in the first message section (e.g., rather than the section section) once the user finishes composing the third message, thereby improving visual feedback to the user.

In some embodiments, the computer system (e.g., 600) receives a swipe input (e.g., 642 as shown in FIG. 6N) (e.g., an upward swipe gesture) in the message transcript. In some embodiments, in response to receiving the swipe input (e.g., 642), the computer system (e.g., 600) redisplays the second message section (e.g., 628a) in the message transcript (e.g., as shown in FIG. 6P). Redisplaying the second message section while in response to receiving the swipe input allows the user to view previously hidden delayed messages in the second message section without having to finish sending the third message, thereby reducing the number of inputs required to perform an operation.

In some embodiments, while the computer system is operating in the delayed messaging mode, the computer system (e.g., 600) starts to compose a fourth message (e.g., 654) (e.g., beginning to draft a message in a message input field (e.g., message bar) while the computer system is not in a delayed messaging mode). In some embodiments, in response to starting to compose the fourth message, the computer system (e.g., 600) maintains display of the second message section (e.g., as shown in FIG. 6L). Maintaining displaying the second message section in response to starting to compose the fourth message section while the computer is operating in a delayed messaging mode provides a visual indication to the user that the fourth message will be displayed in the second message section once the user finishes composing the fourth message, thereby improving visual feedback to the user.

In some embodiments, while the computer system is operating in the delayed messaging mode, the computer system (e.g., 600) receives (e.g., from an external device) a fifth message (e.g., 646 as shown in FIG. 6M). In some embodiments, in response to receiving the fifth message (e.g., 646), the computer system (e.g., 600) displays the fifth message (e.g., 646) in the first message section (e.g., 606) (in some embodiments, displaying the fifth message in the first message section updates the first section such that other previously received and/or transmitted messages in the first section are transitioned off the viewable portion of the message transcript) and maintains the display of the second message section (e.g., 628a) (e.g., the second message section is not updated, and the one or more delayed messages do not move in response to receiving the fifth message). Maintaining the display of the second message section in response to receiving the fifth message allows the user to view an incoming received message without disrupting the process for composing a delayed message thereby making operation of the delayed messaging mode more efficient and reducing the number of inputs to perform an operation.

Note that details of the processes described above with respect to method 800 (e.g., FIG. 8) are also applicable in an analogous manner to the methods described above and below. For example, methods 700 and 1000 optionally include one or more of the characteristics of the various methods described above with reference to method 800. For example, the computer system of method 800 can display, in a message transcript, delayed messages that were composed in a delayed messaging mode via method 700. As another example, the computer system of method 800 can be utilized to display, in a message transcript, delayed linked messages that have respective visual representations that were customized via method 1000. For brevity, these details are not repeated below.

FIGS. 9A-9K illustrate exemplary methods for customizing the visual representation of linked messages in a messaging session, in accordance with some embodiments. The user interfaces in these figures are used to illustrate the processes described below, including the process in FIG. 10.

FIG. 9A illustrates computer system 600, which is a smart phone with touch-sensitive display 602. Although the depicted embodiments show an example in which computer system 600 is a smart phone, in other embodiments, computer system 600 is a different type of computer system (e.g., a tablet, a laptop computer, a desktop computer, a wearable device, and/or a headset). At FIG. 9A, computer system 600 displays messaging user interface 604. Messaging user interface 604 corresponds to a messaging session between a user of computer system 600 and one or more other users, as previously shown in FIGS. 6A-6Z. In some embodiments, preview of drafted messages, displayed in text field 604b, reflect how the messages will be displayed once they are transmitted into the messaging session and displayed in message region 606 (e.g., in response to a user input corresponding to 622a).

Continuing the example of FIG. 9A, computer system 600 displays a preview of linked message 902 in text field 604b. In some embodiments, linked message 902 is automatically generated from copying and pasting a website address (e.g., a URL text string) into text field 604b. In some embodiments, linked message 902 includes thumbnail 902a, which is an image associated with an underlying website of linked message 902, and favicon 902b, which identifies the source (e.g., “Smart Phone Platinum.com”) associated with the underlying website. At FIG. 9A, computer system 600 detects user input 904 (e.g., a tap input or long press input) corresponding to the preview of linked message 902. In some embodiments, user input 904, and other user inputs described in FIGS. 9A-9K, can be a touch input (e.g., a tap input, long press input, and/or a swipe input), an air gesture, and/or a gaze-based input.

At FIG. 9B, in response to user input 904, computer system 600 displays message preview menu 906. In some embodiments, message preview menu 906 includes copy option 906a, customize option 906b, and convert-to-text option 906c. Copy option 906a is a selectable option for copying the preview of linked message 902, which can be pasted into another messaging session. Customize option 906b is a selectable option for modifying the preview of linked message 902 (e.g., as exemplified in FIGS. 9C-9F). Convert-to-text option 906c, is a selectable option for converting the preview of linked message 902 into a URL text string (e.g., a URL associated with the underlying website for linked message 902), such that the URL text string will replace the preview of linked message 902 in text field 604b when convert-to-text option 906c is selected. At FIG. 9B, computer system 600 detects user input 908 (e.g., a tap input) corresponding to customize option 906b.

At FIG. 9C, in response to user input 908, computer system 600 animates the expansion of customization interface 914 (e.g., the full expanded customization interface 914 is shown in FIG. 9D). In some embodiments, while computer system 600 is animating the expansion of customization interface 914, the preview of linked message 902 is emphasized (e.g., stacked on top of linked message 910 and linked message 912), indicating that linked message 902 is the current message preview option prepared for transmission. In some embodiments, while the expansion of customization interface 914 is ongoing, messaging user interface 604a is dimmed (e.g., displayed with reduced brightness) and/or blurred (e.g., displayed with reduced sharpness).

At FIG. 9D, in response to user input 908 and after finishing animating the expansion of customization interface 914, computer system 600 replaces the display of messaging user interface 604 with customization interface 914. In this example, customization interface 914 includes different message preview options with different visual styles including previews for linked message 902 (e.g., the default preview option that was originally displayed in text field 604b at FIG. 9A), linked message 910, and linked message 912. In some embodiments, linked message 902, linked message 910, and linked message 912, all correspond to the same website (e.g., once transmitted, they all are selectable to prompt the display of the same website (e.g., “Smart Phone Platinum.com”)), but have distinct visual styles. For example, while linked message 902 and linked message 910 correspond to the same website, thumbnail 910a is displayed with a different image than thumbnail 902a, and favicon 910b is displayed with a different shading and/or color than favicon 902b. In some embodiments, linked message 912 is displayed as a favicon (e.g., a visual display of a website title) with no corresponding thumbnail. In some embodiments, customization interface 914 additionally includes cancellation button 916, which is selectable to cease displaying customization interface 914 and to redisplay messaging user interface 604 (e.g., as shown in FIG. 9A). At FIG. 9D, computer system 600 detects user input 918 (e.g., a tap input) corresponding to the preview of linked message 910.

At FIG. 9D, in response to user input 918, computer system 600 animates the shrinking of the message preview options (e.g., linked message 902, linked message 910, and linked message 912) in customization interface 914. In some embodiments, while computer system 600 is animating the shrining of the message preview options, the preview of linked message 910 is emphasized (e.g., stacked on top of linked message 902 and linked message 912), indicating that linked message 910 was selected from customization interface 914. In some embodiments, while the shrinking of the message preview options is ongoing, customization interface 914 is dimmed and/or blurred.

At FIG. 9F, in response to user input 918 and after finishing animating the shrinking of the message preview options, computer system 600 replaces the display of customization interface 914 with message user interface 604. Additionally, in response to user input 918, computer system 600 displays the preview of linked message 910 in text field 604b, which replaces the display of linked message 902 (e.g., as previously shown in FIG. 9A). At FIG. 9F, computer system 600 detects user input 920 (e.g., a tap input) corresponding to send icon 622a.

At FIG. 9G, in response to user input 920, computer system 600 displays linked message 910 as a composed message (e.g., a message that has been transmitted into the messaging session) in message region 606. In some embodiments, after displaying linked message 910 in message region 606, linked message 910 can be selected by the user of computer system 600 and/or other participants in the messaging session to prompt the display of the underlying website associated with linked message 910 (e.g., “Smart Phone Platinum.com”).

FIGS. 9H-9K illustrates various examples where computer system 600 displays different types of composed linked messages in message region 606 (e.g., after customizing their respective previews as illustrated in FIGS. 9A-9G). For example, at FIG. 9H, computer system 600 displays linked message 922 in message region 606. In this example, linked message 922 corresponds to playable song “Shake it down” by artist “Granny Smith” on media platform “Music App” (e.g., a local or third-party music streaming service). In some embodiments, linked message 922 includes thumbnail 922a that is stylized based on the underlying linked content of linked message 922 (e.g., an album cover of “Shake it down” sampled from media platform “Music App”). In some embodiments, linked message 922 includes a background color (e.g., a background color displayed behind thumbnail 922a) that is sampled from media platform “Music App” and corresponds to a color used on media platform “Music App” in association with the song “Shake it down” (e.g., the background color of an album page on “Music App” associated with the song “Shake it down”). In some embodiments, a visual representation of linked message 922 (e.g., a visual representation that includes thumbnail 922a as shown in FIGS. 9H-9J) was selected from a variety of customization options (e.g., in customization interface 914 as shown in FIG. 9D) (e.g., including options for thumbnails different from thumbnail 922a) before linked message 922 was transmitted into the messaging session.

At FIG. 9I, computer system 600 displays linked message 924 in message region 606. In this example, linked message 924 corresponds to playable song “Bad Apple” by artist “Granny Smith” on media platform “Music App”. In some embodiments, linked message 924 includes thumbnail 924a that is stylized based on the underlying linked content of linked message 922 (e.g., an album cover for “Bad Apple” sampled from media platform “Music App” that is different from the album cover for “Shake it down”). In some embodiments, linked message 924 includes a background color that is sampled from media platform “Music App” and corresponds to a color used on media platform “Music App” in associated with the song “Bad Apple” (e.g., the background color of an album page on “Music App” associated with the song “Bad Apple”, which is different from the background color of the album page associated with the song “Shake it down”). In some embodiments, a visual representation of linked message 924 (e.g., a visual representation that includes thumbnail 924a as shown in FIGS. 9I and 9J) was selected from a variety of customization options (e.g., in customization interface 914 as shown in FIG. 9D) (e.g., including options for thumbnails different from thumbnail 924a) before linked message 924 was transmitted into the messaging session.

At FIG. 9J, computer system 600 displays linked message 926 in message region 606. In this example, linked message 926 corresponds to playable song “Shake it down” by artist “Granny Smith” on media platform “Poptastic”. In some embodiments, linked message 926 includes thumbnail 926a that is stylized based on the underlying linked content of linked message 926 (e.g., an album cover of “Shake it down” sampled from media platform “Poptastic” that is different from the album cover of “Shake it down” sampled from media platform “Music App”). In some embodiments, linked message 926 is a different shape than message links corresponding to “Signify” (e.g., the body of message link 926 is wider than the body of message link 922 and message link 924). In some embodiments, linked message 926 includes a background color that is sampled from media platform “Poptastic” and corresponds to color used on media platform “Poptastic” in association with the song “Shake it down” (e.g., the background color of an album page on “Poptastic” associated with the song “Shake it down” that is different from the background color of the album page on “Music App” associated with the song “Shake it down”). In some embodiments, a visual representation of linked message 926 (e.g., a visual representation that includes thumbnail 926a as shown in FIG. 9J) was selected from a variety of customization options (e.g., in customization interface 914 as shown in FIG. 9D) (e.g., including options for thumbnails different from thumbnail 926a) before linked message 926 was transmitted into the messaging session.

FIG. 10 is a flow diagram illustrating a method for customizing the visual representation of linked messages in a messaging session in accordance with some embodiments. Method 1000 is performed at a computer system (e.g., 600) (e.g., a smartphone, a smartwatch, a tablet, personal computer and/or a head mounted device). In some embodiments, the computer system (e.g., 600) is in communication with (e.g., includes and/or is connected to) a display generation component (e.g., 602) (e.g., a display, a touch-screen display, a monitor, a holographic display system, and/or a head-mounted display system) and one or more input devices (e.g., 602) (e.g., a touch-sensitive surface (e.g., a touch-sensitive display), a mouse, a keyboard, a remote control, a visual input device (e.g., one or more cameras such as an infrared camera, a depth camera, a visible light camera, and/or a gaze tracking camera), and/or an audio input device (e.g., a microphone)). Some operations in method 1000 are, optionally, combined, the orders of some operations are, optionally, changed, and some operation are, optionally, omitted.

As described below, method 1000 provides an intuitive way customizing the visual representation of linked messages in a messaging session. The method reduces the cognitive burden on a user for customizing the visual representation of linked messages in a messaging session, thereby creating a more efficient human-machine interface. For battery-operated computing devices, enabling a user to customize the visual representation of linked messages faster and more efficiently conserves power and increases the time between battery charges.

The computer system (e.g., 600) displays (1002), via the display generation component (e.g., 602) and in a messaging user interface (e.g., 604) (e.g., an interface for receiving, composing, transmitting, and/or scheduling the delayed transmission of electronic messages (e.g., text messages, audio messages, linked messages, image messages, and/or video messages)), a first preview (e.g., 902) of a first message (e.g., as shown in FIG. 9A) (a visual representation (e.g., a representative image and/or text) of a composed (e.g., drafted in a message input field (e.g., 604b) (e.g., a message bar)) a message that has not yet been transmitted and/or scheduled to be transmitted at a future time) that includes a link (e.g., a hyperlink and/or an embedded link that is selectable once the message has been displayed in the message transcript (e.g., after being transmitted and/or scheduled to be transmitted at a future time)) to a first source (e.g., an application (e.g., a maps application, a media player) and/or a link to website (e.g., an online article website, an online video streaming website)).

While displaying the first preview (e.g., 902), the computer system receives (1004), via the one or more input devices (e.g., 602), a first set of one or more inputs (e.g., 904 and/or 908) (e.g., a tap and/or long press input (e.g., 904) on the first preview (e.g., 902) and/or a subsequent tap and/or long press input (e.g., 908) on a first user interface (e.g., 906) for customizing a respective visual representation of the first message).

In response to receiving the first set of one or more inputs, the computer system (e.g., 600) displays (1006) a first user interface (e.g., 906 and/or 914) for customizing a respective visual representation (e.g., a representative image associated with the link (e.g., a thumbnail), an icon identifying the source of the link (e.g., a favicon), and/or a URL text string corresponding to the source of the link) of the first message, wherein the respective visual representation of the first message is indicative of (e.g., reflects (e.g., is the same as)) a visual representation of the first message as it would be displayed (e.g., as it would appear) on a receiving external device upon transmission of (e.g., sending) the first message to the receiving external device (e.g., a device associated with a contact selected by the user of the computer system)). In some embodiments, the user interface for customizing the respective visual representation of the first message is a menu of selectable options (e.g., options to change the visual representation) for customizing the message. In some embodiments, the user interface for customizing the respective visual representation of the first message includes an arrangement of different visual representation options (e.g., different thumbnail styles (e.g., different colors and/or different images used in the thumbnail) and/or different favicon styles (e.g., different colors and/or different opacities). Displaying, in a first messaging user interface, a first user interface for customizing a respective visual representation of the first message that includes a first link to a first source provides an efficient method for tailoring the visual representation of linked message without having to exit the messaging user interface, thereby reducing the number of inputs required to perform an operation. Further, customizing a respective visual representation of the first message that is indicative of the visual representation of the message as it would be displayed on a receiving external device provides visual confirmation to the user that the visual representation being customized will reflect the visual representation of the message that is ultimately sent, thereby providing improved visual feedback to the user.

In some embodiments, the respective visual representation of the first message includes a first image (e.g., 902a) (e.g., picture of an album cover for link to a streaming service, thumbnail of a static image from video link, cover page of a web article link, and/or picture of a map with respect to a link to a location) of the link and a first source identifier (e.g., 902b) (e.g., an icon that has distinct visual representation depending on the type of source and also has text with a brief description of the source (e.g., website name, song name, music platform name, and/or application name)) corresponding to the first source of the link. Having a respective visual representation of the first message include a first image of the first link and a first source identifier corresponding to the source of the link provide visual aids for the user to identify the underlying content and source of the linked message being sent, thereby providing improved visual feedback to the user.

In some embodiments, in accordance with a determination that the first source is a first type of source (e.g., a website (e.g., a video streaming site or online article website)), the first source identifier (e.g., 902b) is displayed with a first visual style (e.g., as shown in FIGS. 9A-9G). In some embodiments, in accordance with a determination that the first source is a second type of source (e.g., a maps application), the first source identifier (e.g., 928b) is displayed with a second visual style (e.g., as shown in FIG. 9K). Displaying the first source identifier with a first visual style or a second visual style depending on whether the first source is a first type of source, or a second type of source, provides the user with a visual confirmation for which type of linked message will be transmitted, thereby improving the visual feedback for the user.

In some embodiments, the first source identifier (e.g., 902b), is displayed with a first visual style (e.g., as shown in FIGS. 9A-9G), the first source identifier (e.g., 902b) is displayed adjacent to the first image (e.g., 902a) of the link (e.g., the first source identifier does not visually overlap with the first image of the link), and the first source identifier (e.g., 902b) includes a first color (e.g., a background color) used in the first image (e.g., 902a) of the link. Displaying the first source identifier adjacent to the first image of the link and with a first color used in the first image of the link when the first source identifier is displayed with a first visual style provides visual confirmation that the linked message being transmitted is a first type of linked message, thereby improving visual feedback for the user.

In some embodiments, the first source identifier (e.g., 928a) is displayed with a second visual style (e.g., as shown in FIG. 9K), the first source identifier (e.g., 928a) is translucently overlayed (e.g., the first source identifier is translucent (e.g., see through and blurred) and is displayed over the first image of the first link such that first image of the first link is viewable through the first source identifier) on the first image (e.g., 928b) of the link. Translucently overlaying the first source identifier on the first image of the link when the first source identifier is displayed with a second visual style provides visual confirmation that the linked message being transmitted is a second type of linked message, thereby improving visual feedback for the user.

In some embodiments, in accordance with a determination that the first source is a third type of source (e.g., a first music streaming platform), the first image (e.g., 922, 922a, 924 and/or 924a) is displayed with a third visual style (e.g., a first background color) (e.g., as shown in FIGS. 9H-9J). In some embodiments, in accordance with a determination that the first source is a fourth type of source (e.g., a second music streaming platform different from the first music streaming platform), the first image (e.g., 926 and/or 926a) is displayed with a fourth visual style that is different from the third visual style (e.g., a second background color different from the first background color). In some embodiments, in accordance with a determination that the first source is the third type of source, the first source identifier is displayed with a fifth visual style and in accordance with a determination that the first source is the fourth type of source, the first source identifier is displayed with a sixth visual style different from the fifth visual style. Displaying the first image with a third visual style or displaying the first image with a fourth visual style depending on whether the first source is a third type of source, or a fourth type of source, visually confirms the respective type of source of the linked message before the user sends the linked message, thereby providing improved visual feedback to the user.

In some embodiments, displaying the first image (e.g., 922, 922a, 924 and/or 924a) in the third visual style includes displaying the first image with (e.g., uses as a background color) a second color (e.g., purple) associated with the third type of source (e.g., a color associated with the first music streaming platform). In some embodiments, displaying the first image (e.g., 926 and/or 926a) in the fourth visual style includes displaying the first image with a third color (e.g., green) associated with the fourth type of source (e.g., a color associated with the first music streaming platform). Displaying the first image with a second color or displaying the first image with a third color depending on whether the first image is displayed with a third visual style, or a fourth visual style, visually confirms the respective type of source of the linked message before the user sends the linked message, thereby providing improved visual feedback to the user.

In some embodiments, the first image has a fifth visual style that is based on respective content associated with the link to the first source (e.g., as shown in FIG. 9I) (e.g., content (e.g., webpage, song, application page) that is viewable upon selection of the first message, which includes the link to the first source). Displaying a first image with a fifth visual style that is based on respective content associated with the link to the first source provides visual confirmation about the underlying content of the linked message before the user sends the linked message, thereby providing improved visual feedback to the user.

In some embodiments, the first source is a first music streaming platform. In some embodiments, in accordance with a determination that the respective content corresponds to a first song on the first music streaming platform (e.g., a first third party music streaming application), the first image (e.g., 922 and/or 922a) includes a fourth color. In some embodiments, in accordance with a determination that the respective content corresponds to a second song (e.g., different from the first song) on the first music streaming platform, the first image (e.g., 924 and/or 924a) includes a fifth color that is different from the fourth color (e.g., as shown in FIG. 9I). Displaying a first image with a fourth color or displaying the first image with a fifth color depending on whether the respective corresponds to a first song on the first music streaming platform, or to a second song on the first music streaming platform, provides visual confirmation about the underlying content of the linked message before the user sends the linked message, thereby providing improved visual feedback to the user.

In some embodiment, the first preview (e.g., 902) of the first message is a default preview of the first message (e.g., the default preview is always automatically displayed for the first message). Displaying the preview as a default preview allows the user to view a preview of the first message without requiring any inputs to select a particular style of the first preview when the initial preview is desirable, thereby reducing the number of inputs required to perform an operation.

In some embodiments, the first preview (e.g., 902) of the first message is displayed in a message input field (e.g., 604b) (e.g., a message bar) in the messaging user interface (e.g., 604). Displaying the preview in the message input field in the messaging user interface provides visual confirmation that the linked message being displayed is a preview of linked message that has not been sent rather than a linked message that has already been sent, thereby providing improved visual feedback to the user.

In some embodiments, the respective visual representation of the first message is a first visual representation (e.g., 902) of the first message (e.g., a first stylized version of an image and source identifier associated with the link). In some embodiments, the first user interface for customizing the respective visual representation of the first message (e.g., 914) includes a first option for a second visual representation (e.g., 910 and/or 912) (e.g., a second stylized version of the image and source identifier associated with the link) of the first message that is different from the first visual representation (e.g., 902) of the first message (e.g., as shown in FIG. 9D). In some embodiments, the first visual representation of the first message is the same visual representation of the first preview of the first message. Displaying a first user interface for customizing the respective visual representation of the first message that includes a first option for displaying the first message with a second visual representation provides an efficient method for changing the visual representation of linked message without having to exit the messaging user interface, thereby reducing the number of inputs required to perform an operation.

In some embodiments, the first visual representation (e.g., 902) includes a sixth color (e.g., a respective image and/or source identifier (e.g., favicon) uses a sixth color as a background color), and the second visual representation (e.g., 910 and/or 912) includes a seventh color (e.g., a respective image and/or source identifier (e.g., favicon) uses a seventh color as a background color) that is different from the sixth color (e.g., as shown in FIG. 9D). In some embodiments, the second visual representation does not include the sixth color and/or the first visual representation does not include the seventh color. Having the first visual representation that includes a sixth color and displaying an option for the second visual representation that includes a seventh color, provides an efficient method for changing the color used in the linked message without having to exit the messaging user interface, thereby reducing the number of inputs required to perform an operation.

In some embodiments, the first visual representation (e.g., 902) includes a second image (e.g., 902a) of the link and a second source identifier (e.g., 902b) corresponding to the first source of the link, wherein the second image and the second source identifier are displayed in a fifth visual style (e.g., displayed with a first background color used in the second image and/or the second source identifier). In some embodiments, the second visual representation (e.g., 910) includes a third image (e.g., 910a) of the link and a third source identifier (e.g., 910b) corresponding to the first source of the link, wherein the third image and the third source identifier are displayed in a sixth visual style (e.g., displayed with a second background color, different from the first background color, used in the third image and/or the third source identifier) that is different from the fifth visual style (e.g., as shown in FIG. 9D). Having the first visual representation include a second image of the link and a second source identifier and displaying an option for a second visual representation that includes a third image of the link and a third source identifier provides an efficient method for changing the visual appearance of the linked message without having to exit the messaging user interface, thereby reducing the number of inputs required to perform an operation.

In some embodiments, the first visual representation includes a fourth image (e.g., 902a) of the link and a fourth source identifier (e.g., 902b) corresponding to the first source of the link. In some embodiments, the second visual representation (e.g., 912) includes the fourth source identifier and does not include the fourth image of the link (e.g., the fourth source identifier is displayed as an icon without an adjacent image) (e.g., as shown in FIG. 9D). Having the first visual representation include a fourth image of the link and a fourth source identifier and displaying an option for a second visual representation that includes the fourth source identifier but not the fourth image provides an efficient method for changing the visual appearance of the linked message without having to exit the messaging user interface, thereby reducing the number of inputs required to perform an operation.

In some embodiments, the first user interface (e.g., 914) for customizing the respective visual representation of the first message includes a second option for a third visual representation (e.g., 902 as shown in FIG. 9D) of the first message that is the same as the first visual representation (e.g., 902 as shown in FIG. 9A). Displaying a second option for a third visual representation of the first message that is the same as the first visual representation provides an option to maintain the originally designated visual representation of the first message even after displaying the first user interface and without needing to exit the messaging user interface, thereby reducing the number of inputs required to perform an operation.

In some embodiments, the first preview of the first message has the first visual representation (e.g., 902) (e.g., the preview of the first message matches the first visual representation of the first message that is customizable in the first user interface). In some embodiments, the computer system (e.g., 600) receives, via the one or more input devices (e.g., 602), a first input corresponding to the first user interface (e.g., 914 as shown in FIG. 9D). In some embodiments, in response to receiving the first input (e.g., 918) and in accordance with a determination that the first input (e.g., 918) corresponds to (e.g., is directed towards) the first option (e.g., 902) for the second visual representation, the computer system (e.g., 600) ceases to display the first preview with a first visual representation (e.g. 910) and displays the first preview with the second visual representation (e.g., 910 as shown in FIG. 9F). In some embodiments, in response to receiving the first input and in accordance with a determination that the first input corresponds to the second option for the third visual representation (e.g., 902), the computer system (e.g., 600) maintains the display of the first preview with the first visual representation (e.g., 902 as shown in FIG. 9A). In some embodiments, the first user interface ceases to be displayed in response to receiving the first input. Displaying the first preview with the second visual representation or maintaining displaying the first preview with the first visual representation depending on whether the first input corresponds to the first option, or the second option, provides a visual confirmation on whether the visual representation of the linked message has been changed, thereby improving the visual feedback to the user.

In some embodiments, the first set of one or more inputs includes (in some embodiments, is) a second input (e.g., 904) corresponding to the first preview (e.g., 902 as shown in FIG. 9A) of the first message (e.g., a tap input or long press on the first preview). In some embodiment, the first user interface (e.g., 906 as shown in FIG. 9B) is a menu including a plurality of customization options (e.g., 906a, 906b, and/or 906c) for the respective visual representation of the first message. Displaying a menu including a plurality of customization option for the respective visual representation of the first message in response to receiving the second input corresponding to the first preview of the first message provides an efficient selection method for displaying a customization menu without exiting the messaging user interface, thereby reducing the number of inputs required to perform an operation.

In some embodiments, the plurality of customization options includes a first customization option (e.g., 906c as shown in FIG. 9B) that, when selected, causes the respective visual representation of the first message to change to a fourth visual representation of the first message, wherein the fourth visual representation is a string of text (e.g., a URL associated with a website) corresponding to the first source. Displaying a menu with a first customization option for changing the respective visual representation of the first message to a fourth visual representation of the first message that is a string of text corresponding to the first source, provides an efficient selection method for customizing the appearance of a linked message without exiting the messaging user interface, thereby reducing the number of inputs required to perform an operation.

In some embodiments, the plurality of customization options includes a second customization option (e.g., 906b as shown in FIG. 9B) that, when selected (e.g., via user input 908), causes a second user interface (e.g., 914) that includes an arrangement of visual representation options (e.g., different options for different stylized versions of the image and source identifier associated with the link) for the first message to be displayed (e.g., as described above in paragraphs [0266]-[0270]). Displaying a menu with a second customization option that can be selected to display a second user interface that includes an arrangement of visual representation options for the first message provides an efficient selection method for customizing the appearance of a linked message without exiting the messaging user interface, thereby reducing the number of inputs required to perform an operation.

In some embodiments, the computer system (e.g., 600) receives a second input (e.g., 908) (e.g., a tap input) corresponding to the second customization option (e.g., 906b as shown in FIG. 9B). In some embodiments, in response to receiving the second input (e.g., 908), the computer system (e.g., 600) animates (e.g., displaying gradual movement), via the display generation component (e.g., 602), an expansion of the second user interface (e.g., 914) until the second user interface is displayed over the messaging user interface (e.g., 904) (e.g., as shown in FIGS. 9B-9D). In some embodiments, the second user interface is initially displayed at the location of the second customization option (e.g., and/or the location of the first preview) at the beginning of the expansion animation and covers the entire messaging user interface at the end of the expansion animation. Animating the expansion of the second user interface until the second user interface is displayed over the messaging user interface provides the user with visual cues that the second user interface is associated with the messaging user interface and not part of a separate application and/or user interface. Animating this expansion, rather than immediately displaying the second user interface, also allows the user to recognize that the second user interface corresponds to the selection of the second customization options, thereby providing improved visual feedback to the user.

In some embodiments, while displaying the second user interface (e.g., 914) over the messaging user interface (e.g., 904), the computer system (e.g., 600) receives a third input to exit the second user interface (e.g., by selection of an exit affordance (e.g., 916) or selection of an option (e.g., 902, 910, or 912 as shown in FIG. 9D) in the arrangement of visual representation options (e.g., as described above in paragraphs [0266]-[02670])). In some embodiments, in response to receiving the third input, the computer system (e.g., 600) animates, via the display generation component (e.g., 602), shrinking of the second user interface (e.g., 614) until the second user interface (e.g., 614) ceases to be displayed in the messaging user interface (e.g., 604) (e.g., as shown in FIGS. 9D-9F). In some embodiments, the second user interface covers the entire messaging user interface at the beginning of the shrinking animation and is displayed at the location of the second customization option (e.g., and/or the location of the first preview) at the end of the animation just before the second user interface ceases to be displayed. Animating shrinking of the second user interface until the second user interface ceases to be displayed, rather than immediately ceasing the display of the second user interface, allows the user to recognize that the second user interface was properly exited, thereby providing improved visual feedback to the user.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the efficiency of composing messages in various user interfaces. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to compose messages in various user interfaces. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of composing message, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, messages can be composed based on non-personal information data or a bare minimum amount of personal information, such as the content being requested by the device associated with a user, other non-personal information available to the content delivery services, or publicly available information.

What is claimed is:

1. A computer system configured to communicate with a display generation component and one or more input devices, comprising:
one or more processors; and
memory storing one or more programs configured to be executed by the one or more processors, the one or more programs including instructions for:
while displaying, via the display generation component, a messaging user interface, receiving, via the one or more input devices, a first set of one or more inputs;
in response to receiving the first set of one or more inputs, activating a delayed messaging mode, wherein the computer system is configured to schedule delayed transmission times of respective messages while operating in the delayed messaging mode; and
while operating in the delayed messaging mode:
composing a first message; and
composing a second message, wherein the first message and the second message are scheduled to be transmitted at a first predetermined time.

2. The computer system of claim 1, wherein:
a first menu of a plurality of message composition options is displayed in the messaging user interface, wherein the plurality of message composition options includes a delayed messaging mode option; and
the first set of one or more inputs includes a first input corresponding to the delayed messaging mode option, wherein the delayed messaging mode is activated in response to receiving a first input.

3. The computer system of claim 1, the one or more programs further including instructions for:
while operating in the delayed messaging mode, displaying, in the messaging user interface and via the display generation component, a delivery time indicator that identifies the first predetermined time, and wherein the delivery time indicator, when selected, initiates a process for changing the first predetermined time to a second predetermined time.

4. The computer system of claim 1, wherein the first predetermined time is a default time.

5. The computer system of claim 1, the one or more programs further including instructions for:
while operating in the delayed messaging mode, displaying, in the messaging user interface and via the display generation component, a selectable cancellation interface object that, when selected, causes deactivation of the delayed messaging mode.

6. The computer system of claim 5, the one or more programs further including instructions for:
after composing the first message and the second message in the delayed messaging mode, receiving a second input corresponding to the selectable cancellation interface object;
in response to receiving the second input, deactivating the delayed messaging mode; and
while the delayed messaging mode is deactivated and while continuing to display the messaging user interface, composing a third message without delaying a transmission time of the third message.

7. The computer system of claim 1, wherein:
the messaging user interface includes a first message input field;
the first message is a first type of message; and
composing the first message includes displaying, in the first message input field and via the display generation component, a first preview of the first message with a first visual representation; and
the one or more programs further include instructions for:
while the computer system is not operating in the delayed messaging mode, composing a fourth message of the first type of message, wherein composing the fourth message includes displaying, in the first message input field and via the display generation component, a second preview of the fourth message with a second visual representation that is different from the first visual representation.

8. The computer system of claim 7, wherein the first type of message is a message that includes a respective image.

9. The computer system of claim 7, wherein the first type of message is a message that includes a link to a respective source.

10. The computer system of claim 7, wherein the first type of message is an audio message.

11. The computer system of claim 1, the one or more programs further including instructions for:
while operating in the delayed messaging mode, displaying, in the messaging user interface and via the display generation component, a first selectable message composition object, wherein:
the messaging user interface includes a first message transcript;
composing the first message includes:
receiving, via the one or more input devices, a fourth input corresponding to the first selectable message composition object; and
in response to receiving the fourth input, displaying, via the display generation component, the first message in the first message transcript; and
composing the second message includes:
receiving, via the one or more input devices, a fifth input corresponding to the first selectable message composition object; and
in response to receiving the fifth input, displaying, via the display generation component, the second message in the first message transcript.

12. The computer system of claim 11, wherein:
The first message transcript includes a first message section that includes one or more transmitted messages; and
the first message and the second message are displayed in a first subsection of a second message section of the first message transcript that is visually separated from the first message section of the first message transcript.

13. The computer system of claim 12, the one or more programs further including instructions for:
while the computer system is operating in the delayed messaging mode, composing a fifth message, wherein the fifth message is scheduled to be transmitted at a second predetermined time different from the first predetermined time; and
in response to composing the fifth message, displaying, via the display generation component, the fifth message in a second subsection of the second message section that is visually separated from the first subsection of the second message section.

14. The computer system of claim 1, wherein the first message includes first content that is received while the computer system is not operating in the delayed messaging mode.

15. The computer system of claim 1, wherein the second message includes second content that is received while the computer system is operating in delayed messaging mode.

16. The computer system of claim 1, wherein:
the messaging user interface includes a second message input field;
in accordance with a determination that the computer system is operating in the delayed messaging mode, the second message input field is displayed in a first visual style; and
in accordance with a determination that the computer system is not operating in the delayed messaging mode, the second message input field is displayed in a second visual style that is different from the first visual style.

17. The computer system of claim 16, wherein:
the second message input field includes a second selectable message composition object that is selectable to compose a respective message;
in accordance with a determination that the computer system is operating in the delayed messaging mode, the second selectable message composition object is presented in a third visual style; and
in accordance with a determination that the computer system is not operating in the delayed messaging mode, the second selectable message composition object is presented in a fourth visual style that is different than the third visual style.

18. The computer system of claim 1, wherein:
the messaging user interface includes a second message transcript with a first received message;
the first message includes third content that is received via the one or more input devices, wherein receiving the third content includes:
receiving a sixth input corresponding to the first received message; and
in response to receiving the sixth input, displaying, via the display generation component, a third message input field; and
receiving a seventh input to prepare the third content in the third message input field.

19. A non-transitory computer-readable storage medium storing one or more programs configured to be executed by one or more processors of a computer system that is in communication with a display generation component and one or more input devices, the one or more programs including instructions for:
while displaying, via the display generation component, a messaging user interface, receiving, via the one or more input devices, a first set of one or more inputs;
in response to receiving the first set of one or more inputs, activating a delayed messaging mode, wherein the computer system is configured to schedule delayed transmission times of respective messages while operating in the delayed messaging mode; and
while operating in the delayed messaging mode:
composing a first message; and
composing a second message, wherein the first message and the second message are scheduled to be transmitted at a first predetermined time.

20. A method, comprising:
at a computer system that is in communication with a display generation component and one or more input devices:
while displaying, via the display generation component, a messaging user interface, receiving, via the one or more input devices, a first set of one or more inputs;
in response to receiving the first set of one or more inputs, activating a delayed messaging mode, wherein the computer system is configured to schedule delayed transmission times of respective messages while operating in the delayed messaging mode; and
while operating in the delayed messaging mode:
composing a first message; and
composing a second message, wherein the first message and the second message are scheduled to be transmitted at a first predetermined time.
